(19) United States
(12) Patent Application Publication
(10) Pub. No.: US 2025/0224550 A1
(43) Pub. Date: Jul. 10, 2025

(54) MULTIPLE WAVELENGTH RANGE IMAGING LIGHT GUIDE SYSTEM

(71) Applicant: Vuzix Corporation, West Henrietta, NY (US)

(72) Inventor: Robert J. Schultz, Victor, NY (US)

(21) Appl. No.: 18/853,115

(22) PCT Filed: Mar. 31, 2023
(86) PCT No.: PCT/US2023/017217

§ 371 Date: Sep. 30, 2024

Related U.S. Application Data
(60) Provisional application No. 63/326,177, filed on Mar. 31, 2022.

(51) Int. Cl. F21V 8/00

(52) U.S. Cl. CPC G02B 6/0016; G02B 6/0036; G02B 6/0076; G02B 6/0088

(57) ABSTRACT

An image light guide system for conveying a virtual image that includes a first waveguide and a second waveguide operable to propagate image-bearing light beams. The first waveguide includes a first in-coupling diffractive optic formed along the first waveguide, wherein the first in-coupling diffractive optic is operable to diffract a first portion of image-bearing light beams from a first image source into the first waveguide in an angularly encoded form and a first out-coupling diffractive optic formed along the first waveguide, and wherein the first out-coupling diffractive optic is operable to replicate the first portions of image-bearing light beams and direct the replicated image-bearing light beams from the first waveguide in an angularly decoded form.

### TECHNICAL FIELD

The present disclosure relates generally to electronic displays and more particularly to displays utilizing image light guides with diffractive optics to convey image-bearing light to a viewer.

### BACKGROUND

Head-Mounted Displays (HMDs) and virtual image near-eye displays are being developed for a range of diverse uses, including military, commercial, industrial, fire-fighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

Although conventional image light guide arrangements have provided significant reduction in bulk, weight, and overall cost of near-eye display optics, further improvements are needed. In some instances, image resolution is constrained by a reduction in the bulk and cost of conventional image light guide arrangements. Similarly, diffraction and propagation of certain wavelengths of light can underperform in a conventional image light guide arrangement. Thus, there is a need for an image light guide system operable to produce the desired virtual image brightness and resolution while managing the bulk and cost of the system.

### SUMMARY

In a first exemplary embodiment, the present disclosure provides an image light guide for conveying a virtual image including, a first waveguide operable to propagate image-bearing light beams, a first in-coupling diffractive optic formed along the first waveguide, wherein the first in-coupling diffractive optic is operable to diffract a first portion of image-bearing light beams from a first image source into the first waveguide in an angularly encoded form, a first out-coupling diffractive optic formed along the first waveguide, wherein the first out-coupling diffractive optic is operable to replicate the first portions of image-bearing light beams and direct the replicated image-bearing light beams from the first waveguide in an angularly decoded form, a second in-coupling diffractive optic formed along the first waveguide, wherein the second in-coupling diffractive optic is operable to diffract a first portion of image-bearing light beams from a second image source into the first waveguide in an angularly encoded form, a second out-coupling diffractive optic formed along the first waveguide, wherein the second out-coupling diffractive optic is operable to replicate the first portions of image-bearing light beams and direct the replicated image-bearing light beams from the first waveguide in an angularly decoded form, a second waveguide operable to propagate image-bearing light beams, a third in-coupling diffractive optic formed along the second waveguide, wherein the third in-coupling diffractive optic is operable to diffract a second portion of image-bearing light beams from the first image source into the second waveguide in an angularly encoded form, a third out-coupling diffractive optic formed along the second waveguide, wherein the second out-coupling diffractive optic is operable to replicate the second portions of image-bearing light beams and direct the replicated image-bearing light beams from the second waveguide in an angularly decoded form, a fourth in-coupling diffractive optic formed along the second waveguide, wherein the fourth in-coupling diffractive optic is operable to diffract a second portion of image-bearing light beams from the second image source into the second waveguide in an angularly encoded form; and a fourth out-coupling diffractive optic formed along the second waveguide, wherein the fourth out-coupling diffractive optic is operable to replicate the second portions of image-bearing light beams and direct the replicated image-bearing light beams from the second waveguide in an angularly decoded form.

In a second exemplary embodiment, the present disclosure provides an image light guide for conveying a virtual image including, a first waveguide operable to propagate image-bearing light beams, a first in-coupling diffractive optic formed along the first waveguide, wherein the first in-coupling diffractive optic is operable to diffract a first portion of image-bearing light beams from a first image source into the first waveguide in an angularly encoded form, a first out-coupling diffractive optic formed along the first waveguide, wherein the first out-coupling diffractive optic is operable to replicate the first portions of image-bearing light beams and direct the replicated image-bearing light beams from the first waveguide in an angularly decoded form, a second waveguide operable to propagate image-bearing light beams; a second in-coupling diffractive optic formed along the second waveguide, wherein the second in-coupling diffractive optic is operable to diffract a first portion of image-bearing light beams from a second image source into the second waveguide in an angularly encoded form, a second out-coupling diffractive optic formed along the second waveguide, wherein the second out-coupling diffractive optic is operable to replicate the first portions of image-bearing light beams and direct the replicated image-bearing light beams from the second waveguide in an angularly decoded form, a third waveguide operable to propagate image-bearing light beams, a third in-coupling diffractive optic formed along the third waveguide, wherein the third in-coupling diffractive optic is operable to diffract a first portion of image-bearing light beams from a third image source into the third waveguide in an angularly encoded form, and a third out-coupling diffractive optic formed along the third waveguide, wherein the third out-coupling diffractive optic is operable to replicate the first portion of image-bearing light beams and direct the replicated image-bearing light beams from the third waveguide in an angularly decoded form.

In a third exemplary embodiment, the present disclosure provides an image light guide for conveying a virtual image including, a first waveguide operable to propagate image-bearing light beams, a first in-coupling diffractive optic formed along the first waveguide, wherein the first in-coupling diffractive optic is operable to diffract a first portion of image-bearing light beams from a first image source into the first waveguide in an angularly encoded form, a first out-coupling diffractive optic formed along the first waveguide, wherein the first out-coupling diffractive optic is operable to replicate the first portions of image-bearing light beams and direct the replicated image-bearing light beams from the first waveguide in an angularly decoded form, a second waveguide operable to propagate image-bearing light beams, a second in-coupling diffractive optic formed along the second waveguide, wherein the second in-coupling diffractive optic is operable to diffract a first portion of image-bearing light beams from a second image source into the second waveguide in an angularly encoded form, a second out-coupling diffractive optic formed along the second waveguide, wherein the second out-coupling diffractive optic is operable to replicate the first portion of image-bearing light beams and direct the replicated image-bearing light beams from the second waveguide in an angularly decoded form, a third in-coupling diffractive optic formed along the second waveguide, wherein the third in-coupling diffractive optic is operable to diffract a first portion of image-bearing light beams from a third image source into the second waveguide in an angularly encoded form, and a third out-coupling diffractive optic formed along the second waveguide, wherein the third out-coupling diffractive optic is operable to replicate the first portion of image-bearing light beams and direct the replicated image-bearing light beams from the second waveguide in an angularly decoded form.

In a fourth exemplary embodiment, the present disclosure provides an image light guide for conveying a virtual image, including, a first waveguide operable to propagate image-bearing light beams; a first in-coupling diffractive optic formed along the first waveguide, wherein the first in-coupling diffractive optic is operable to diffract a first portion of image-bearing light beams from a first image source into the first waveguide in an angularly encoded form, a first out-coupling diffractive optic formed along the first waveguide, wherein the first out-coupling diffractive optic is operable to replicate the first portions of image-bearing light beams and direct the replicated image-bearing light beams from the first waveguide in an angularly decoded form, a second in-coupling diffractive optic formed along the first waveguide, wherein the second in-coupling diffractive optic is operable to diffract a first portion of image-bearing light beams from the first image source into the first waveguide in an angularly encoded form, and a second out-coupling diffractive optic formed along the first waveguide, wherein the second out-coupling diffractive optic is operable to replicate the first portion of image-bearing light beams and direct the replicated image-bearing light beams from the first waveguide in an angularly decoded form.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 shows a simplified cross-sectional view of an image light guide showing the replication of an image-bearing beam along the direction of propagation for expanding one direction of an eyebox.

FIG. 2 shows a perspective view of an image light guide with a turning grating showing the expansion of an image-bearing beam perpendicular to the direction of propagation for expanding a second direction of an eyebox.

FIG. 3 shows a schematic side view of stacked waveguides having multiple in-coupling diffractive optics according to an exemplary embodiment of the presently disclosed subject matter.

FIG. 4 shows a schematic top plan view of a first waveguide according to FIG. 3.

FIG. 5 shows a schematic bottom plan view of the first waveguide according to FIG. 3.

FIG. 6 shows a schematic top plan view of a second waveguide according to FIG. 3.

FIG. 7 shows a schematic bottom plan view of the second waveguide according to FIG. 3.

FIG. 8 shows a schematic end view of the stacked waveguides according to FIG. 3.

FIG. 9 shows a schematic end view of the stacked waveguide according to FIG. 3.

FIG. 10 shows a schematic view of the in-coupling diffractive optics and a birefringent polarization control element of the stacked waveguides according to FIGS. 8 and 9.

FIGS. 11 and 12 show schematic perspective views of the stacked waveguides according to FIG. 3.

FIG. 13 shows a schematic side view of a portion of a reflective type in-coupling diffractive optic.

FIG. 14 shows a schematic side view of a portion of a transmissive type in-coupling diffractive optic.

FIG. 15 shows a schematic side view of stacked waveguides having multiple in-coupling diffractive optics according to another exemplary embodiment of the presently disclosed subject matter.

FIG. 16 shows a schematic side view of stacked waveguides having multiple in-coupling diffractive optics according to FIG. 15, except having waveguides of increasing length from the bottom to the top.

FIG. 17 shows a schematic side view of stacked waveguides having multiple in-coupling diffractive optics according to FIG. 15, and also having optical elements.

FIG. 18 shows a schematic top plan view of stacked waveguides having multiple in-coupling diffractive optics according to yet another exemplary embodiment of the presently disclosed subject matter.

FIGS. 19A shows a schematic side view of stacked waveguides having multiple in-coupling diffractive optics according to another exemplary embodiment of the presently disclosed subject matter.

FIG. 19B shows a schematic end view of stacked waveguides having multiple in-coupling diffractive optics according to FIG. 19A.

FIG. 20A shows a schematic top plan view of a double-sided waveguide having multiple in-coupling diffractive optics according to another exemplary embodiment of the presently disclosed subject matter.

FIG. 20B shows a schematic side view of the double-sided waveguide having multiple in-coupling diffractive optics according to FIG. 20A.

FIG. 20C shows a schematic end view of a waveguide having multiple in-coupling diffractive optics according to FIG. 20A.

FIG. 20D shows a schematic end view of a waveguide having multiple in-coupling diffractive optics according to FIG. 20A.

FIG. 21A shows a schematic side view of the double-sided waveguide having multiple in-coupling diffractive optics according to FIG. 20A.

FIG. 21B shows a schematic side view of the double-sided waveguide having multiple in-coupling diffractive optics according to FIG. 20A.

FIG. 22A shows a schematic top plan view of a double-sided waveguide having multiple in-coupling diffractive optics according to another exemplary embodiment of the presently disclosed subject matter.

FIG. 22B shows a schematic side view of the double-sided waveguide according to FIG. 22A.

FIG. 22C shows a schematic portion of a compound diffractive grating pattern operable to expand and out-couple image-bearing light beams according to an exemplary embodiment of the presently disclosed subject matter.

FIG. 22D shows a diagram of grating vectors for a first optical path of a first wavelength of image-bearing light through the double-sided waveguide of FIG. 22A.

FIG. 22E shows a diagram of grating vectors for a second optical path of a second wavelength of image-bearing light through the double-sided waveguide of FIG. 22A.

FIG. 22F shows a diagram of grating vectors for a third optical path of a third wavelength of image-bearing light through the double-sided waveguide of FIG. 22A.

FIG. 23 shows a perspective view of a display system for augmented reality viewing using imaging light guides according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, and “user” are considered equivalents and refer to the person, or machine, who wears and/or views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the terms “wavelength band” and “wavelength range” are equivalent and have their standard connotation as used by those skilled in the art of color imaging and refer to a continuous range of light wavelengths that are used to represent polychromatic images.

Where used herein, the term “beam expansion” is intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

An optical system, such as a HMD, can produce a virtual image display. In contrast to methods for forming a real image, a virtual image is not formed on a display surface. That is, if a display surface were positioned at the perceived location of a virtual image, no image would be formed on that surface. Virtual image display has a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or buried within the waveguide. Such diffractive optics can be formed as diffraction gratings, holographic optical elements (HOEs) or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along at least one direction of the virtual image. In addition, a turning grating can be positioned on/in the waveguide to provide pupil expansion in an orthogonal direction of the virtual image. The image-bearing light output from the waveguide provides an expanded eyebox for the viewer.

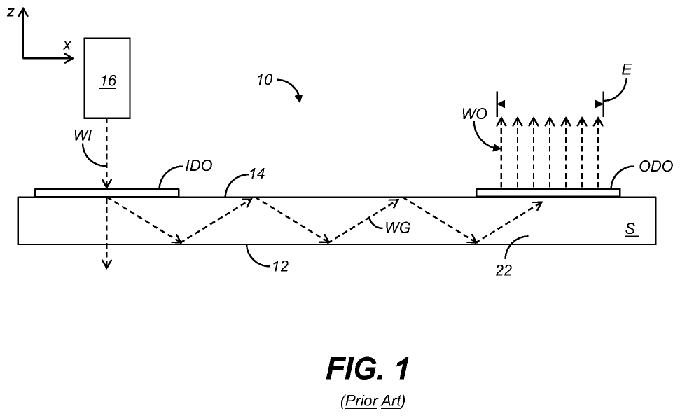

As illustrated in FIG. 1, an image light guide 10 may comprise a planar waveguide 22 having plane-parallel surfaces. The waveguide 22 comprises a transparent substrate S having an outer surface 12 and an inner surface 14 located opposite the outer surface 12. In this example, an in-coupling diffractive optic IDO and an out-coupling diffractive optic ODO are arranged on the inner surface 14 and the in-coupling diffractive optic IDO is a reflective-type diffraction grating through which image-bearing light WI is coupled into the planar waveguide 22. However, the in-coupling diffractive optic IDO could alternately be a volume hologram or other holographic diffraction element, or other type of optical component that provides diffraction for the incoming, image-bearing light WI. The in-coupling diffractive optic IDO can be located on the outer surface 12 or the inner surface 14 of the planar waveguide 22 and can be of a transmissive or reflective type depending upon the direction from which the image-bearing light WI approaches the planar waveguide 22.

When used as a part of a virtual display system, the in-coupling diffractive optic IDO couples the image-bearing light WI from a real image source into the substrate S of the planar waveguide 22. Any real image or image dimension is first converted into an array of overlapping angularly related beams encoding the different positions within an image for presentation to the in-coupling diffractive optic IDO. The image-bearing light WI is diffracted (generally through a first diffraction order) and thereby redirected by in-coupling diffractive optic IDO into the planar waveguide 22 as image-bearing light WG for further propagation along the planar waveguide 22 by Total Internal Reflection (“TIR”). Although diffracted into a generally more condensed range of angularly related beams in keeping with the boundaries set by TIR, the image-bearing light WG preserves the image information in an encoded form. The out-coupling diffractive optic ODO receives the encoded image-bearing light WG and diffracts (also generally through a first diffraction order) the image-bearing light WG out of the planar waveguide 22 as the image-bearing light WO toward the intended location of a viewer's eye, e.g., toward an eyebox E. Generally, the out-coupling diffractive optic ODO is designed symmetrically with respect to the in-coupling diffractive optic IDO to restore the original angular relationships of the image-bearing light WI among outputted angularly related beams of the image-bearing light WO. However, to increase one dimension of overlap among the angularly related beams populating the eyebox E within which the virtual image can be seen, the out-coupling diffractive optic ODO is arranged together with a limited thickness of the image light guide 12 to encounter the image-bearing light WG multiple times and to diffract only a portion of the image-bearing light WG on each encounter. The multiple encounters along the length of the out-coupling diffractive optic ODO have the effect of replicating the image-bearing light beams WG and enlarging or expanding at least one dimension of the eyebox E where the replicated beams overlap. The expanded eyebox E decreases sensitivity to the position of a viewer's eye for viewing the virtual image.

Out-coupling diffractive optics with refractive index variations along a single direction can expand one dimension of the eyebox by replicating the individual angularly related beams in their direction of propagation along the waveguide between encounters with the out-coupling diffractive optic. In addition, out-coupling diffractive optics with refractive index variations along a second direction can expand a second dimension of the eyebox and provide two-dimensional expansion of the eyebox. The refractive index variations along a first direction of the out-coupling diffractive optic can be arranged to diffract a portion of each beam's energy out of the waveguide upon each encounter therewith through a desired first order of diffraction, while another portion of the beam's energy is preserved for further propagation in its original direction through a zero order of diffraction. The refractive index variations along a second direction of the out-coupling diffractive optic can be arranged to diffract a portion of each beam's energy upon each encounter therewith through a desired first order of diffraction in a direction angled relative to the beam's original direction of propagation, while another portion of the beam's energy is preserved for further propagation in its original direction through a zero order of diffraction.

In FIG. 1, the out-coupling diffractive optic ODO is shown as a transmissive-type diffraction grating arranged on the inner surface 14 of the planar waveguide 22. However, like the in-coupling diffractive optic IDO, the out-coupling diffractive optic ODO can be located on the outer surface 12 or the inner surface 14 of the planar waveguide 22 and be of a transmissive or reflective type in a combination that depends upon the direction through which the image-bearing light WG is intended to exit the planar waveguide 22.

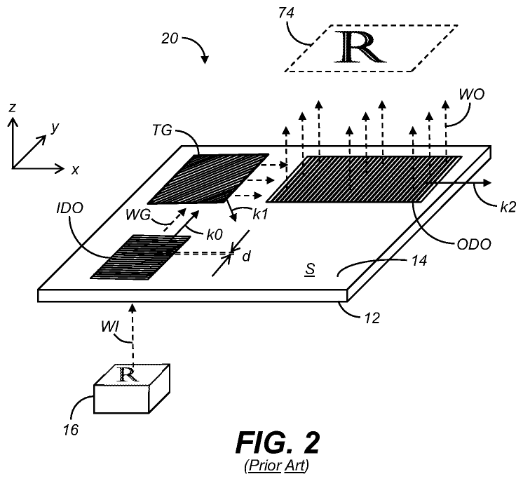

As illustrated in FIG. 2, an image light guide 20 may be arranged for expanding an eyebox 74 in two directions, i.e., along both x- and y-axes of the intended image. To achieve a second direction of beam replication, the in-coupling diffractive optic IDO, having a grating vector k0, is oriented to diffract a portion of the image-bearing light WI toward an intermediate turning grating TG, having a grating vector k1, which is oriented to diffract a portion of the image-bearing light WG in a reflective mode toward the out-coupling diffractive optic ODO. Only a portion of the image-bearing light WG is diffracted by each of multiple encounters with intermediate turning grating TG thereby laterally replicating each of the angularly related beams of the image-bearing light WG approaching the out-coupling diffractive optic ODO. The turning grating TG redirects the image-bearing light WG toward the out-coupling diffractive optic ODO for longitudinally replicating the angularly related beams of the image-bearing light WG in a second direction before exiting the planar waveguide 22 as the image-bearing light WO. Grating vectors, such as the depicted grating vectors k0, k1, k2, extend in a direction that is normal to the diffractive features (e.g., grooves, lines, or rulings) of the diffractive optics and have a magnitude inverse to the period or pitch d (i.e., the on-center distance between grooves) of the diffractive optics IDO, TG, ODO. The in-coupling diffractive optic IDO, the turning grating TG, and the out-coupling diffractive optic ODO may each have a different period or pitch d.

As illustrated in FIG. 2, the in-coupling diffractive optic IDO receives the incoming image-bearing light WI containing a set of angularly related beams corresponding to individual pixels or equivalent locations within an image generated by an image source 16. The image source 16, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. The image light guide 20 provides an expanded eyebox by providing multiple encounters of the image-bearing light WG with both the intermediate turning grating TG and the out-coupling diffractive optic ODO in different orientations. In the original orientation of the planar waveguide 22, the intermediate grating TG provides beam replication in the y-axis direction, and the out-coupling diffractive optic ODO provides a similar beam replication in the x-axis direction. The reflectivity characteristics and respective periods d of the diffractive optics IDO, ODO, TG, together with the orientations of their respective grating vectors, provide for eyebox expansion in two directions while preserving the intended relationships among the angularly related beams of the image-bearing light WI that are output from the image light guide 20 as the image-bearing light WO.

While the image-bearing light WI input into the image light guide 20 is encoded into a different set of angularly related beams by the in-coupling diffractive optic IDO, the information required to reconstruct the image is preserved by accounting for the systematic effects of the in-coupling diffractive optic IDO. The turning grating TG, located in an intermediate position between the in-coupling and out-coupling diffractive optics IDO, ODO, is typically arranged so that it does not induce any significant change on the encoding of the image-bearing light WG. The out-coupling diffractive optic ODO is typically arranged in a symmetric fashion with respect to the in-coupling diffractive optic IDO, e.g., including diffractive features sharing the same period. Similarly, the period of the turning grating TG also typically matches the common period of the in-coupling and out-coupling diffractive optics IDO, ODO. As illustrated in FIG. 2, the grating vector k1 of the turning grating TG may be oriented at 45 degrees with respect to the other grating vectors k0, k2 (all as undirected line segments). However, in an example embodiment, the grating vector k1 of the turning grating TG is oriented at 60 degrees to the grating vectors k0, k2 of the in-coupling and out-coupling diffractive optics IDO, ODO in such a way that the image-bearing light WG is turned 120 degrees. By orienting the grating vector k1 of the intermediate turning grating TG at 60 degrees with respect to the grating vectors k0, k2 of the in-coupling and out-coupling diffractive optics IDO, ODO, the grating vectors k0, k2 are also oriented at 60 degrees with respect to each other (again considered as undirected line segments). Basing the grating vector magnitudes on the common pitch of the turning grating TG and the in-coupling and out-coupling diffractive optics IDO, ODO, the three grating vectors k0, k1, k2 (as directed line segments) form an equilateral triangle, and sum to a zero-vector magnitude, which avoids asymmetric effects that could introduce unwanted aberrations including chromatic dispersion.

The image-bearing light WI that is diffracted into the planar waveguide 22 is effectively encoded by the in-coupling diffractive optic IDO, whether the in-coupling diffractive optic IDO uses gratings, holograms, prisms, mirrors, or some other mechanism. Any reflection, refraction, and/or diffraction of light that takes place at the in-coupling diffractive optic IDO must be correspondingly decoded by the out-coupling diffractive optic ODO to re-form the virtual image that is presented to the viewer. The turning grating TG, placed at an intermediate position between the in-coupling and out-coupling diffractive optics IDO, ODO, is typically designed and oriented so that it does not induce any change on the encoded light. The out-coupling diffractive optic ODO decodes the image-bearing light WG into its original or desired form of angularly related beams that have been replicated into an output beam array to fill the eyebox 74.

Whether any symmetries are maintained or not among the turning grating TG and the in-coupling and out-coupling diffractive optics IDO, ODO or whether any change to the encoding of the angularly related beams of the image-bearing light WI takes place along the planar waveguide 22, the turning grating TG and the in-coupling and out-coupling diffractive optics IDO, ODO are related so that the image-bearing light WO that is output from the planar waveguide 22 preserves or otherwise maintains the original or desired form of the image-bearing light WI for producing the intended virtual image.

The letter “R” represents the orientation of the virtual image that is visible to the viewer whose eye is in the eyebox 74. As shown, the orientation of the letter “R” in the represented virtual image matches the orientation of the letter “R” as encoded by the image-bearing light WI. A change in the rotation about the z axis or angular orientation of incoming image-bearing light WI with respect to the x-y plane causes a corresponding symmetric change in rotation or angular orientation of outgoing light from out-coupling diffractive optic ODO. From the aspect of image orientation, the turning grating TG simply acts as a type of optical relay, providing replication of the angularly encoded beams of the image-bearing light WG along one axis (e.g., along the y-axis) of the image. The out-coupling diffractive optic ODO further replicates the angularly encoded beams of the image-bearing light WG along another axis (e.g., along the x-axis) of the image while maintaining the original orientation of the virtual image encoded by the image-bearing light WI. As illustrated in FIG. 2, the turning grating TG may be a slanted or square grating arranged on the front or back surfaces of the planar waveguide 22. Alternately, the turning grating TG may be a blazed grating.

The present disclosure provides for an image light guide arrangement having improved image-bearing light output intensity across the output aperture. More specifically, the present disclosure provides for, inter alia, a waveguide having more than one in-coupling diffractive optic and an out-coupling diffractive optic operable to replicate image-bearing light beams in two-directions and output the replicated image-bearing light beams toward an eyebox.

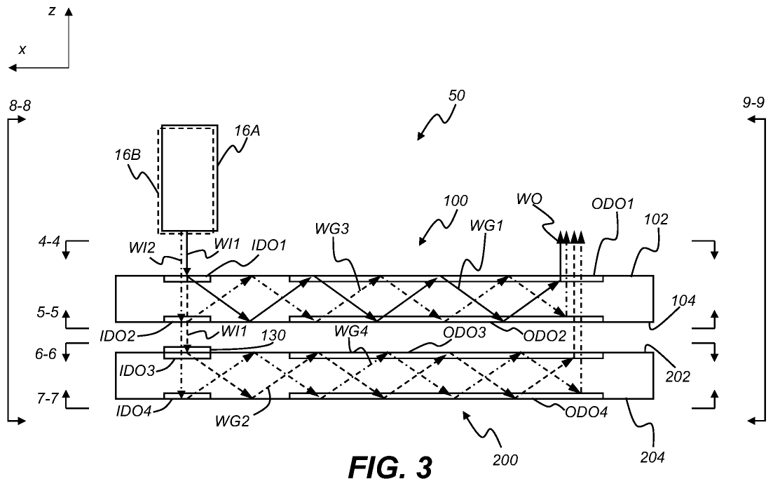

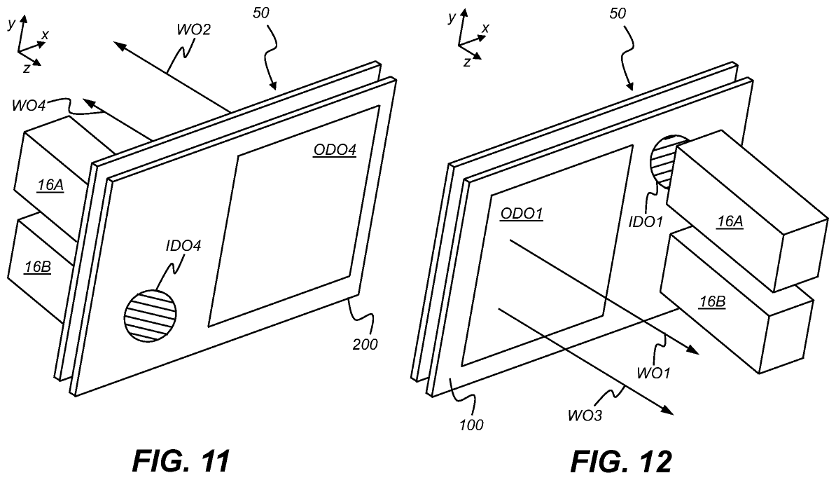

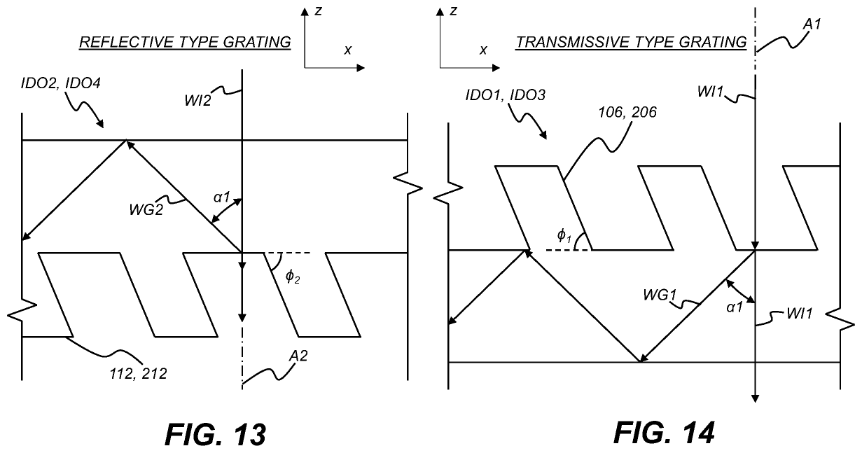

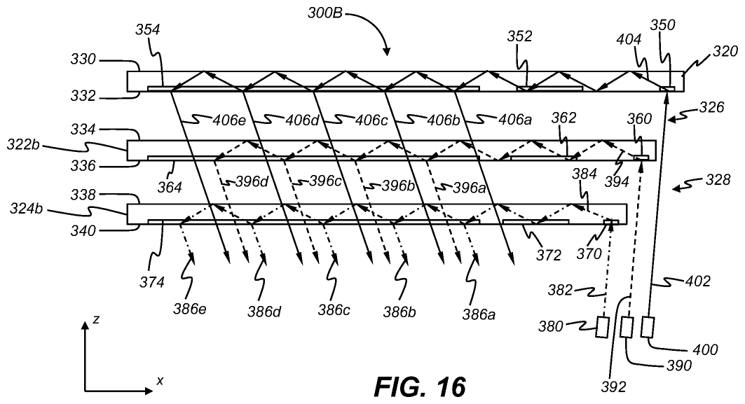

As illustrated in FIG. 3-11, in an example embodiment, an image light guide system 50 includes a first planar waveguide 100 having a first surface 102 and a second surface 104. The waveguide first surface 102 is positioned generally parallel with the waveguide second surface 104. A first in-coupling diffractive optic IDO1 is located on, in, or engaged with the first surface 102 and a second in-coupling diffractive optic IDO2 is located on, in, or engaged with the second surface 104. Additionally, a first out-coupling diffractive optic ODO1 is formed on, in, or engaged with the first surface 102 and a second out-coupling diffractive optic ODO2 is formed on, in, or engaged with the second surface 104. In an example embodiment, the out-coupling diffractive optics ODO1, ODO2, are each a diffraction grating. In another example embodiment, the out-coupling diffractive optics ODO1, ODO2 are each a holographic diffraction element.

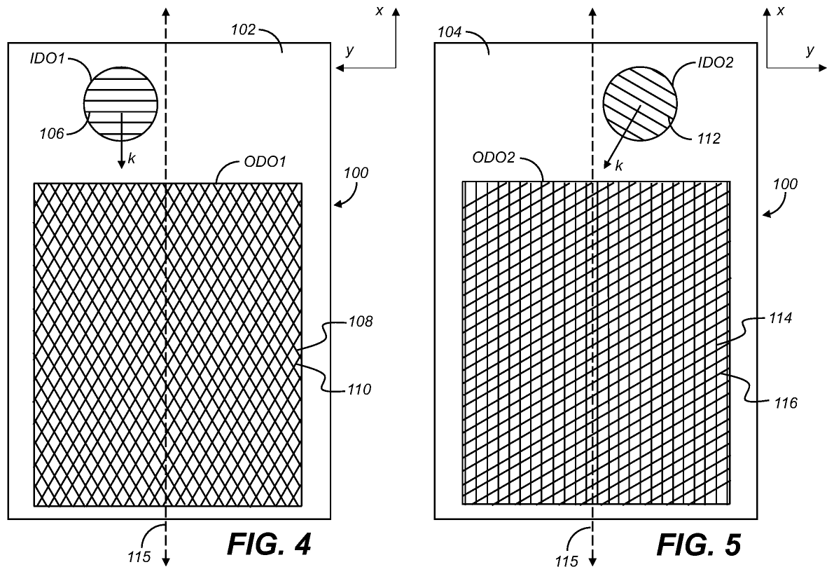

Referring now to FIG. 4, which illustrates a top plan view of an example embodiment of first planar waveguide 100, the first in-coupling diffractive optic IDO1 includes a first plurality of periodic diffractive structures 106. For example, the first in-coupling diffractive optic IDO1 may comprise a first set of periodic linear grating structures 106 positioned generally parallel with the y-axis. The first out-coupling diffractive optic ODO1 includes a second plurality of periodic diffractive structures 108 and a third plurality of periodic diffractive structures 110. For example, the second plurality of periodic diffractive structures 108 may comprise a second set of periodic linear grating structures 108 rotated or angularly offset relative to the x-axis 115 by a polar angle (measured from the x-axis 115) less than thirty degrees (e.g., 25°) and the third plurality of periodic diffractive structures 110 may comprise a third set of periodic linear grating structures 110 rotated or angularly offset relative to the x-axis 115 by a polar angle greater than sixty degrees, e.g., 65°. In an example embodiment, the second set of periodic linear grating structures 108 are rotated or angularly offset relative to the x-axis 115 by a polar angle of approximately 30° and the third set of periodic linear grating structures 110 are rotated or angularly offset relative to the x-axis 115 by a polar angle of approximately 150°. In another embodiment (not illustrated), the first set of periodic linear grating structures 106 are positioned generally parallel to an alternative axis that is not the y-axis, and further the second set of periodic linear grating structures 108 are rotated or angularly offset relative to an axis perpendicular to the alternative axis by a polar angle (measured from the perpendicular axis) less than thirty degrees (e.g., 25°) while the third set of periodic linear grating structures 110 are rotated-or angularly offset relative to the alternative axis by a polar angle (measured from the perpendicular axis) greater than sixty degrees (e.g., 65°). The second and third sets of periodic diffractive structures 108, 110 are crossed and/or define different grating vectors. The second and third sets of periodic diffractive structures 108, 110 form a compound diffractive optic operable to replicate and out-couple image-bearing light in-coupled by the first in-coupling diffractive optic IDO1. The first set of periodic diffractive structures 106 comprises a first period, the second set of periodic diffractive structures 108 comprise a second period, and the third set of periodic diffractive structures 110 comprise a third period. In an example embodiment, the third period is equal to the second period, and the second period is equal to the first period. In an example embodiment, the first period, the second period, and the third period are each less than 50 nm.

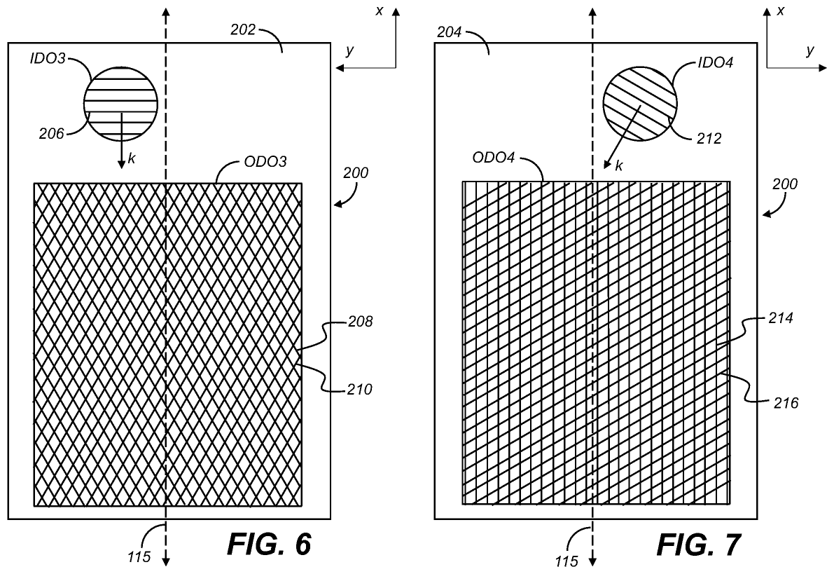

Referring now to FIG. 5, which illustrates a bottom plan view of first planar waveguide 100, the second in-coupling diffractive optic IDO2 includes a fourth plurality of periodic diffractive structures 112. For example, the second in-coupling diffractive optic IDO2 may comprise a fourth set of periodic linear grating structures 112 rotated or angularly offset relative to the first set of periodic linear grating structures 106 by approximately thirty degrees) (30°), e.g., within 5 degrees (5°) of thirty degrees) (30°). For example, the second in-coupling diffractive optic IDO2 may comprise the fourth set of periodic linear grating structures 112 rotated or angularly offset relative to the first set of periodic linear grating structures 106 by between 25 degrees (25°) and 35 degrees (35°). The second out-coupling diffractive optic ODO2 includes a fifth plurality of periodic diffractive structures 114 and a sixth plurality of periodic diffractive structures 116. For example, the fifth plurality of periodic diffractive structures 114 may comprise a fifth set of periodic linear grating structures 114 rotated or angularly offset relative to the second set of periodic linear grating structures 108 by approximately thirty degrees) (30°) or thirty degrees) (30°), and the sixth plurality of periodic diffractive structures 116 may comprise a sixth set of periodic linear grating structures 116 rotated or angularly offset relative to the third set of periodic linear grating structures 110 by approximately thirty degrees) (30°) or within 5 degrees (5°) of thirty degrees) (30°). In an example embodiment, the fifth set of periodic linear grating structures 114 is substantially parallel with the x-axis 115 having a polar angle of approximately 0° and the sixth set of periodic linear grating structures 116 is rotated or angularly offset relative to the x-axis 115 by a polar angle of approximately 120°. The fifth and sixth sets of periodic diffractive structures 114, 116 are crossed and/or define different grating vectors. The fifth and six sets of periodic diffractive structures 114, 116 form a compound diffractive optic operable to replicate and out-couple image-bearing light from the second in-coupling diffractive optic IDO2. The fourth set of periodic diffractive structures 112 comprises a fourth period, the fifth set of periodic diffractive structures 114 comprise a fifth period, and the sixth set of periodic diffractive structures 116 comprise a sixth period. In an example embodiment, the sixth period is equal to the fifth period, and the fifth period is equal to the sixth period. In an example embodiment, the first period, the second period, and the third period are each less than 50 nm and the fourth period, the fifth period and the sixth period are each greater than 50 nm.

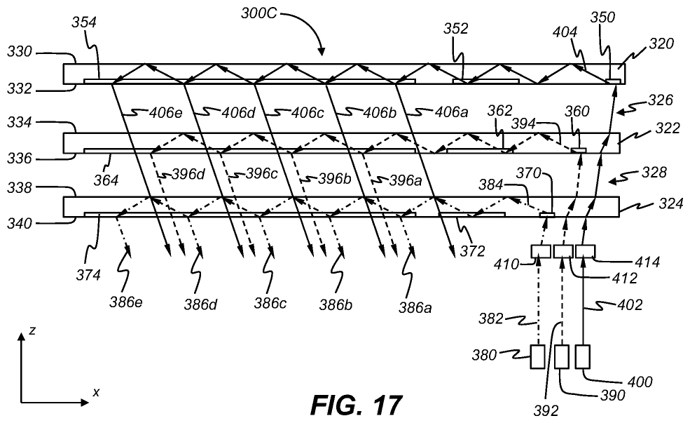

As illustrated in FIGS. 3-12, in an example embodiment, the image light guide system 50 includes a second planar waveguide 200 having a first surface 202 and a second surface 204. The waveguide first surface 202 is positioned generally parallel with the waveguide second surface 204. A third in-coupling diffractive optic IDO3 is located on, in, or engaged with the first surface 202 and a fourth in-coupling diffractive optic IDO4 is located on, in, or engaged with the second surface 204. A third out-coupling diffractive optic ODO3 is formed on/in the first surface 202 and a fourth out-coupling diffractive optic ODO4 is formed on, in, or engaged with the second surface 204. In an example embodiment, the first in-coupling diffractive optic IDO1 is located substantially co-axial to the third in-coupling diffractive optic IDO3 with respect to an axis arranged through the first and second surface 102, 104 of the first planar waveguide 100 and through the first and second surface 202, 204 of the second planar waveguide 200. Similarly, the second in-coupling diffractive optic IDO2 is located substantially co-axial with the fourth in-coupling diffractive optic IDO4 with respect to an axis arranged through the first and second surface 102, 104 of the first planar waveguide 100 and through the first and second surface 102, 104 of the second planar waveguide 200.

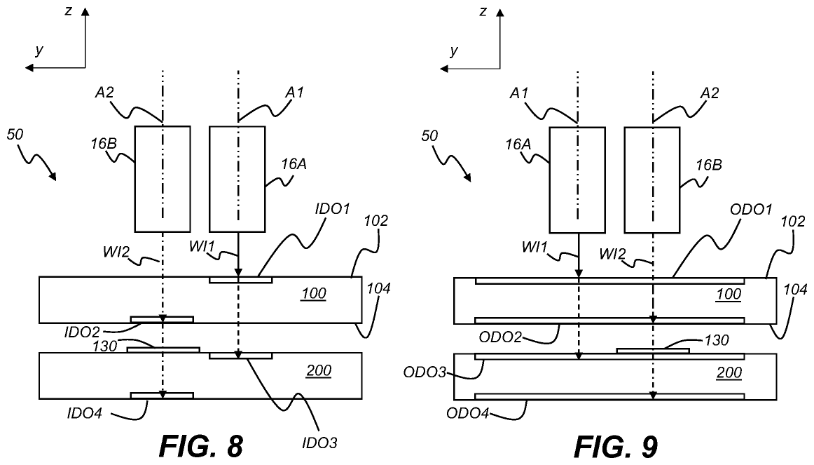

Referring now to FIG. 6, which illustrates a top plan view of an example embodiment of second planar waveguide 200, the third in-coupling diffractive optic IDO3 includes a seventh plurality of periodic diffractive structures 206. For example, the third in-coupling diffractive optic IDO3 may comprise a seventh set of periodic linear grating structures 206 positioned generally parallel with the y-axis. The third out-coupling diffractive optic ODO3 includes an eighth plurality of periodic diffractive structures 208 and a ninth plurality of periodic diffractive structures 210. For example, the eighth plurality of periodic diffractive structures 208 may comprise an eighth set of periodic linear grating structures 208 rotated or angularly offset relative to the x-axis by a polar angle (measured from the x-axis) less than thirty degrees (e.g., 25°) and the ninth plurality of periodic diffractive structures 210 may comprise a ninth set of periodic linear grating structures 210 rotated or angularly offset relative to the x-axis by a polar angle (measured from the x-axis) greater than sixty degrees (e.g., 65°). In another embodiment (not illustrated), the seventh set of periodic linear grating structures 206 are positioned generally parallel to an alternative axis that is not the y-axis, and further the eighth set of periodic linear grating structures 208 are rotated or angularly offset relative to an axis perpendicular to the alternative axis by a polar angle (measured from the perpendicular axis) less than thirty degrees (e.g., 25°) while the ninth set of periodic linear grating structures 210 are rotated or angularly offset relative to the alternative axis by a polar angle (measured from the perpendicular axis) greater than sixty degrees (e.g., 65°). In an example embodiment, the eighth set of periodic linear grating structures 208 are rotated or angularly offset relative to the x-axis 115 by a polar angle of approximately 30° and the ninth set of periodic linear grating structures 210 are rotated or angularly offset relative to the x-axis 115 by a polar angle of approximately 150°. The eighth and ninth sets of periodic diffractive structures 208, 210 are crossed and/or define different grating vectors. The eighth and ninth sets of periodic diffractive structures 208, 210 form a compound diffractive optic operable to replicate and out-couple image-bearing light from the third in-coupling diffractive optic IDO3. The seventh set of periodic diffractive structures 206 comprises a seventh period, the eighth set of periodic diffractive structures 208 comprise an eighth period, and the ninth set of periodic diffractive structures 210 comprise a ninth period. In an example embodiment, the ninth period is equal to the eighth period, and the eighth period is equal to the seventh period. In an example embodiment, the seventh period, the eighth period, and the ninth period are each less than 50 nm.

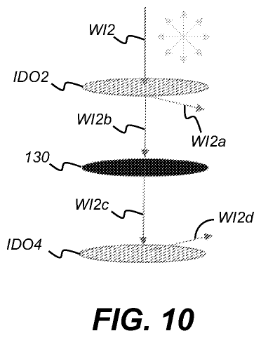

Referring now to FIG. 7, which illustrates a bottom plan view of second planar waveguide 200, the fourth in-coupling diffractive optic IDO4 includes a tenth plurality of periodic diffractive structures 212. For example, the fourth in-coupling diffractive optic IDO4 may comprise a tenth set of periodic linear grating structures 212 rotated or angularly offset relative to the seventh set of periodic linear grating structures 206 by approximately thirty degrees) (30°) e.g., within five degrees) (5°) of thirty degrees) (30°). For example, the fourth in-coupling diffractive optic IDO4 may comprise the tenth set of periodic linear grating structures 212 rotated or angularly offset relative to the seventh set of periodic linear grating structures 206 by between 25 degrees (25°) and 35 degrees (30°). The fourth out-coupling diffractive optic ODO4 includes an eleventh plurality of periodic diffractive structures 214 and a twelfth plurality of periodic diffractive structures 216. For example, the eleventh plurality of periodic diffractive structures 214 may comprise an eleventh set of periodic linear grating structures 214 rotated or angularly offset relative to the eighth set of periodic linear grating structures 208 by approximately thirty degrees (30°), e.g., within five degrees (5°) of thirty degrees (30°), and the twelfth plurality of periodic diffractive structures 216 may comprise a twelfth set of periodic linear grating structures 216 rotated or angularly offset relative to the ninth set of periodic linear grating structures 210 by approximately thirty degrees (30°), e.g., within five degrees (5°) of thirty degrees (30°). In an example embodiment, the eleventh set of periodic linear grating structures 214 is substantially parallel with the x-axis 115 having a polar angle of approximately 0° and the twelfth set of periodic linear grating structures 216 is rotated or angularly offset relative to the x-axis 115 by a polar angle of approximately 120°. The eleventh and twelfth sets of periodic diffractive structures 214, 216 are crossed and/or define different grating vectors. The eleventh and twelfth sets of periodic diffractive structures 214, 216 form a compound diffractive optic operable to replicate and out-couple image-bearing light from the fourth in-coupling diffractive optic IDO4. The tenth set of periodic diffractive structures 212 comprises a tenth period, the eleventh set of periodic diffractive structures 214 comprise an eleventh period, and the twelfth set of periodic diffractive structures 216 comprise a twelfth period. In an example embodiment, the twelfth period is equal to the eleventh period, and the eleventh period is equal to the tenth period. In an example embodiment, the tenth period, the eleventh period and the twelfth period are each less than 50 nm and the tenth period, the eleventh period and the twelfth period are each greater than 50 nm.

The first planar waveguide 100 comprises a first wavelength range light path and a second a wavelength range light path. The first wavelength range light path comprises at least the first in-coupling diffractive optic IDO1 and the first out-coupling diffractive optic ODO1. The first wavelength range light path is operable to in-couple, propagate via TIR, replicate and out-couple image-bearing light of a first wavelength range. For example, the first wavelength range light path is operable to direct image-bearing light in the blue wavelength range (e.g., in the 440-470 nm range or between 450-495 nm range) through the waveguide 100. The second wavelength range light path comprises at least the second in-coupling diffractive optic IDO2 and the second out-coupling diffractive optic ODO2. The second wavelength range light path is operable to in-couple, propagate via TIR, replicate and out-couple image-bearing light of a second wavelength range. For example, the second wavelength range light path is operable to direct image-bearing light in the red wavelength range (e.g., in the 630-660 nm range or 620-750 nm range) through the waveguide 100.

The second planar waveguide 200 comprises a third wavelength range light path and a fourth wavelength range light path. The third wavelength range light path comprises at least the third in-coupling diffractive optic IDO3 and the third out-coupling diffractive optic ODO3. The third wavelength range light path is operable to in-couple, propagate via TIR, replicate and out-couple image-bearing light of a third wavelength range. For example, the third wavelength range light path is operable to direct image-bearing light in the green wavelength range (e.g., in the 520-560 nm range or 495-570 nm range) through the waveguide 200. The fourth wavelength range light path comprises at least the fourth in-coupling diffractive optic IDO4 and the fourth out-coupling diffractive optic ODO4. The fourth wavelength range light path is also operable to in-couple, propagate via TIR, replicate and out-couple image-bearing light of the second wavelength range. For example, the fourth wavelength range light path is operable to direct image-bearing light in the red wavelength range (e.g., in the 630-660 nm range or 620-750 nm range) through the waveguide 200.

With respect to the first planar waveguide 100, by rotating the fourth plurality of periodic diffractive structures 112 generally thirty degrees (303) relative to the first plurality of periodic diffractive structures 106 and by rotating the fifth and sixth pluralities of periodic diffractive structures 114, 116 generally thirty degrees)(30°) relative to the second and third pluralities of periodic diffractive structures 108, 110, respectively, crosstalk (e.g., interference between in-coupled light of different wavelength ranges) between the first and second wavelength range light paths is reduced. In other words, the diffractive elements of the second in-coupling diffractive optic IDO2 are rotated generally thirty degrees (30°) relative to the diffractive elements of the first in-coupling diffractive optic IDO1, and the diffractive elements of the second out-coupling diffractive optic ODO2, are rotated generally thirty degrees (30°) relative to the diffractive elements of the first out-coupling diffractive optic ODO1.

Crosstalk can also be reduced between the third and fourth wavelength range light paths by rotating the tenth plurality of periodic diffractive structures 212 generally thirty degrees (30°) relative to the seventh plurality of periodic diffractive structures 206, and by rotating the eleventh and twelfth pluralities of grating structures 214, 216 generally thirty degrees (30°) relative to the eighth and ninth pluralities of periodic diffractive structures 208, 210, respectively. In other words, the fourth in-coupling diffractive optic IDO4 is rotated generally thirty degrees (30°) relative to the third in-coupling diffractive optic IDO3, and the fourth out-coupling diffractive optic ODO4, is rotated generally thirty degrees (30°) relative to the third out-coupling diffractive optic ODO3. As shown in FIGS. 4-7, in an example embodiment, the first, second and third sets of periodic linear grating structures 106, 108, 110 and the seventh, eighth, and ninth sets of periodic linear grating structures 206, 208, 210 on the first surface 102 of the first waveguide 100 and the first surface 202 of the second waveguide 200, respectively, each generally have the same period. In an example embodiment, the first, second, third, seventh eighth and ninth sets of periodic linear grating structures each have periods that are greater than 50 nm. Similarly, the fourth, fifth and sixth sets of periodic linear grating structures 112, 114, 116 and the tenth, eleventh, and twelfth sets of periodic linear grating structures 212, 214, 216 on the second surface 104 of the first waveguide 100 and the second surface 204 of the second waveguide 200, respectively, each generally have the same period. In an example embodiment, the first, second, third, seventh, eighth, and ninth periodic linear grating structures 106, 108, 110, 206, 208, 210 each have a period that is greater than 50 nm, and the fourth, fifth and sixth, tenth, eleventh, and twelfth sets of periodic linear grating structures 112, 114, 116, 212, 214, 216 each have a period that is less than 50 nm. In another example embodiment, the first, second, third, seventh, eighth, and ninth periodic linear grating structures 106, 108, 110, 206, 208, 210 each have a period that is less than 50 nm, and the fourth, fifth and sixth, tenth, eleventh, and twelfth sets of periodic linear grating structures 112, 114, 116, 212, 214, 216 each have a period that is greater than 50 nm. Moreover, the orientation of the first, second, and third sets of periodic linear grating structures 106, 108, 110 are arranged in substantially the same orientation as the seventh, eighth, and ninth sets of periodic linear grating structures 206, 208, 210, respectively. Similarly, the orientation of fourth, fifth, and sixth sets of periodic linear grating structures 112, 114, 116 are arranged in substantially the same orientation as the tenth, eleventh, and twelfth sets of periodic linear grating structures 212, 214, 216, respectively. As used herein, and in addition to its ordinary meaning to those in the art, the term “orientation” is meant to refer to the position and/or angle of the set of periodic linear grating structures relative to the x-axis 115.

As illustrated in FIGS. 3, 8 and 9, in an example embodiment, image-bearing light WI1 from the projector 16A is incident upon the first in-coupling diffractive optic IDO1, a first portion of the image-bearing light WI1 is diffracted by the first in-coupling diffractive optic IDO1 and generally propagates toward the out-coupling diffractive optic ODO1 via TIR as WG1. In one example, the periodic linear grating structures of first in-coupling diffractive optic IDO1 (i.e., first set of periodic linear grating structures 106), are arranged to optimize coupling of a first range of wavelengths of image-bearing light WI1, e.g., light within the blue wavelength range of the electromagnetic spectrum. A second portion of the image-bearing light WI1 transmits through the first in-coupling diffractive optic IDO1 and the planar waveguide 100 and is incident upon the third in-coupling diffractive optic IDO3. At least a portion of the image-bearing light WI1 is diffracted by the third in-coupling diffractive optic IDO3 and generally propagates toward the second out-coupling diffractive optic ODO2 via TIR as WG2. In one example, the periodic linear grating structures of third in-coupling diffractive optic IDO3 (i.e., seventh set of periodic linear grating structures 206) are arranged to optimized coupling of a second range of wavelengths of image-bearing light WI1, e.g., light within the green wavelength range.

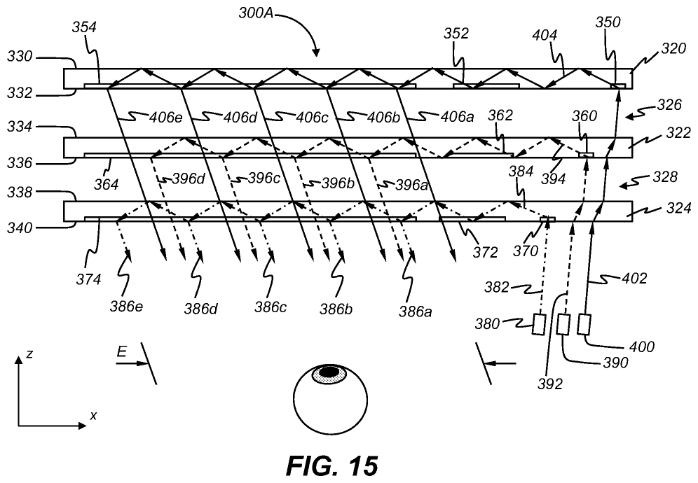

Image-bearing light WI2 from the projector 16B is incident upon the second in-coupling diffractive optic IDO2, a first portion of the image-bearing light WI2 is diffracted by the second in-coupling diffractive optic IDO2 and generally propagates toward the out-coupling diffractive optic ODO2 via TIR as WG3. In one example, the periodic linear grating structures of second in-coupling diffractive optic IDO2 (i.e., fourth set of periodic linear grating structures 112), are arranged to optimize coupling of a range of wavelengths of image-bearing light WI2 within the red wavelength range. A second portion of the image-bearing light WI2 transmits through the second in-coupling diffractive optic IDO2 and the planar waveguide 200 and is incident upon the fourth in-coupling diffractive optic IDO4. In one example, the periodic linear grating structures of fourth in-coupling diffractive optic IDO4 (i.e., tenth set of periodic linear grating structures 210), are arranged to optimize coupling of a third range of wavelengths of image-bearing light WI2, e.g., light within the red wavelength range of the electromagnetic spectrum. At least a portion of the image-bearing light WI2 is diffracted by the fourth in-coupling diffractive optic IDO4 and generally propagates toward the second out-coupling diffractive optic ODO2 via TIR as WG4. A birefringent polarization control element 130 may be located between waveguide 100 and waveguide 200. In an example embodiment, the birefringent polarization control element 130 is substantially coaxial with IDO2 and IDO4 along an axis that passes through the first and second surfaces 102, 104 of first planar waveguide 100 and the first and second surfaces 202, 204 of the second planar waveguide 200. The birefringent polarization control element 130 may be operable to turn the polarization direction of the image-bearing light ninety degrees ninety degrees (90°). Additionally, it should be appreciated that, transmissive-type diffraction gratings have lower polarization sensitivity than reflective-type diffraction gratings. Where the second in-coupling diffractive optic IDO2 is a reflective-type diffraction grating, polarization of the image-bearing light via the birefringent polarization control element 130 enables a greater diffraction efficiency. As shown in FIG. 10, in an example embodiment, image-bearing light WI2 from the projector 16B is incident upon the second in-coupling diffractive optic IDO2, and second in-coupling diffractive optic IDO2 is optimized to diffract or in-couple a first portion WI2a of image-bearing light WI2 into the first planar waveguide 100. For example, the second in-coupling diffractive optic IDO2 can be configured to in-couple first portion WI2a of image-bearing light WI2, where the first portion WI2a is comprised of light having electric fields that are parallel with the periodic diffractive structures of the second in-coupling diffractive optic IDO2 (hereinafter “parallel electric field light”) and light having electric fields that are perpendicular to the orientation of the periodic diffractive structures of the second in-coupling diffractive optic IDO2 (herein after “perpendicular electric field light”). In some example embodiments, the ratio of parallel electric field light to perpendicular electric field light that couples into the waveguide 100 is selected from a range of ratios between 8:1 and 6:1. In one example embodiment, 85% of the parallel electric field light that diffracts from second in-coupling diffractive optic IDO2 is coupled into waveguide 100, and approximately 15% of the perpendicular electric field light that diffracts from second in-coupling diffractive optic IDO2 is coupled into waveguide 100. A second portion WI2b of image-bearing light WI2 is transmitted through the second in-coupling diffractive optic IDO2. The second portion WI2b of image-bearing light WI2 encounters the birefringent polarization control element 130, which is operable to alter the polarization states of light within the second portion WI2b of image-bearing light WI2 transmitted through second in-coupling diffractive optic IDO2. In one example, the birefringent polarization control element 130 is selected from one or more of a half-wave plate, a quarter-wave plate, or a retarding film. In one example, the birefringent polarization control element 130 is a half-wave plate configured to rotate the polarization states of light within the second portion WI2b of image-bearing light WI2 e.g., ninety-degrees, to provide a third portion WI2c of image-bearing light WI2. The third portion WI2c of the image-bearing light WI2 is diffracted by the fourth in-coupling diffractive optic IDO4 to provide a fourth portion WI2d of image-bearing light WI2, wherein the fourth portion WI2d includes light having a ratio of parallel electric field light to perpendicular electric field light selected from a range of ratios between 1:8 and 1:6. In other words, in one example embodiment, 15% of the parallel electric field light that diffracts from fourth in-coupling diffractive optic IDO4 is coupled into waveguide 200, and approximately 85% of the perpendicular electric field light that diffracts from fourth in-coupling diffractive optic IDO4 is coupled into waveguide 200. The fourth portion WI2d of image-bearing light WI2 is in-coupled into the planar waveguide 200 and generally propagates toward the fourth out-coupling diffractive optic ODO4 via TIR as in-coupled image-bearing light WG4.

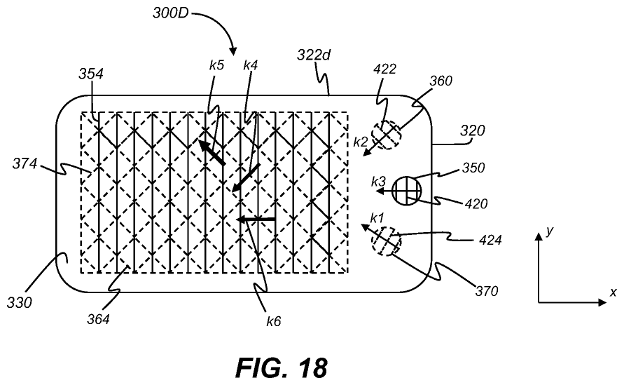

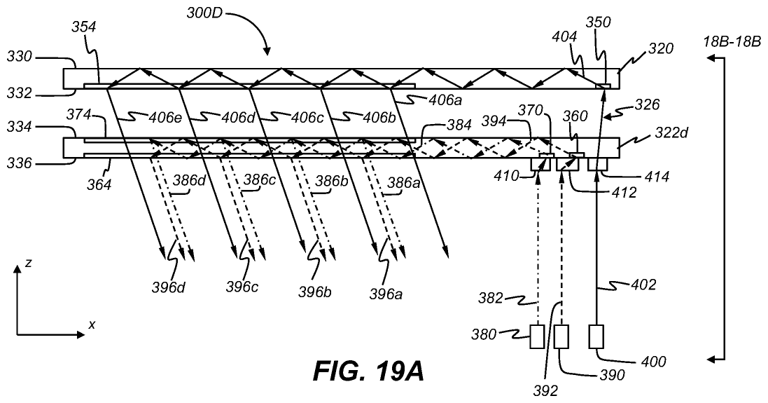

In an example embodiment, as illustrated in FIGS. 13 and 14, the first in-coupling diffractive optic IDO1 and the third in-coupling diffractive optic IDO3 are configured to optimize diffractive efficiency for image-bearing light WI1. For example, the first in-coupling diffractive optic IDO1 and the third in-coupling diffractive optic IDO3 may be configured as transmissive-type diffraction gratings and the second in-coupling diffractive optic IDO2 and the fourth in-coupling diffractive optic IDO4 may be configured as reflective-type diffraction gratings. In an example embodiment, the first plurality of periodic diffractive structures 106 of the first in-coupling diffractive optic IDO1 may have a slant angle ϕ₁ and the fourth plurality of periodic diffractive structures 112 of the second in-coupling diffractive optic IDO2 may have a slant angle ϕ₂. Similarly, the seventh plurality of periodic diffractive structures 206 of the third in-coupling diffractive optic IDO3 may have a slant angle ϕ₁ and the tenth plurality of periodic diffractive structures 212 of the fourth in-coupling diffractive optic IDO4 may have a slant angle ϕ₂. The periodic diffractive structures 106, 112 of the first and second in-coupling diffractive optics IDO1, IDO2 may have slant angles ϕ that are rotated one-hundred-eighty degrees relative to each other.

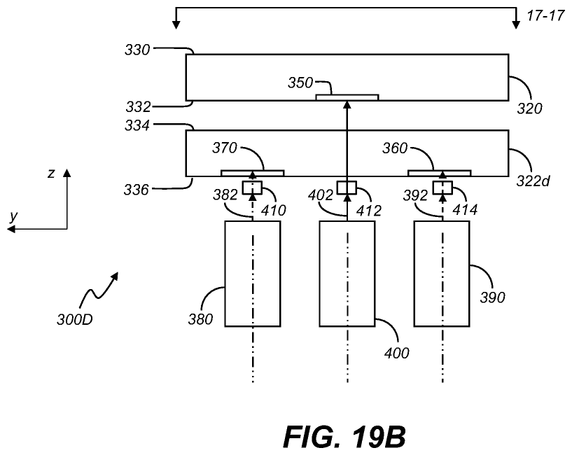

As illustrated in FIG. 15, in an example embodiment, an image light guide system 300A includes a first planar waveguide 320, a second planar waveguide 322, and a third planar waveguide 324. The first planar waveguide 320 has a top planar surface 330 and a bottom planar surface 332 that is generally parallel to the top planar surface 330. The first planar waveguide 320 includes an in-coupling diffractive optic 350 located on the bottom planar surface 332. The first planar waveguide 320 may also include an intermediate diffractive optic 352 oriented to diffract a portion of the image-bearing light in a reflective mode toward an out-coupling diffractive optic 354. The intermediate diffractive optic 352 may be referred to herein as a turning grating. In an example embodiment, the turning grating 352 is a diffraction grating. In another example embodiment, the turning grating 352 is a holographic optical element. Turning grating 352 is operable replicate an image-bearing light beam traveling within the first planar waveguide 320 in one or more directions providing pupil expansion, i.e., eyebox expansion, in one or more directions.

The out-coupling diffractive optic 354 is operable to diffract a portion of the image-bearing light beams propagating within the first planar waveguide 320 out of the first planar waveguide 320. In an example embodiment, the out-coupling diffractive optic 354 is a diffraction grating. In another example embodiment, the out-coupling diffractive optic 354 is a holographic diffraction element. The out-coupling diffractive optic 354 may be arranged to encounter image-bearing light beams multiple times to provide eyebox (E) expansion in one or more dimensions. For example, refractive index variations along a single direction can expand one dimension of the eyebox (E) by promoting multiple encounters of the angularly related beams in their direction of propagation along the out-coupling diffractive optic 354 of the first planar waveguide 320.

The image light guide system 300A also includes an image beam source 400 that produces an image-bearing light beam 402. In an example embodiment, the image beam source 400 is a pico-projector. For example, the image beam source 400 may be a pico-projector that produces a single primary color band, (red, green, or blue wavelengths), of an image to be presented to a viewer looking generally along the z-axis direction through the image light guide system 300A. Image beam source 400 may be positioned such that a central ray of the projected image-bearing light beam 402 is generally perpendicular (e.g., within five degrees (5°) of perpendicular, to the third planar waveguide 324 bottom surface 340. The image beam source 400 may also be positioned such that the projected image-bearing light beam 402 central ray is not generally perpendicular to the third planar waveguide 324 bottom surface 340.

As illustrated in FIG. 15, in an example embodiment, the image-bearing light beam 402 passes through the third planar waveguide 324 and the second planar waveguide 322 to the in-coupling diffractive optic 350 of the first planar waveguide 320 where a portion of the image-bearing light beam 402 is diffracted into the first planar waveguide 320 as in-coupled image-bearing light beam 404. The in-coupled image-bearing light beam 404 propagates through the first planar waveguide 320 by total internal reflection (TIR) between top planar surface 330 and bottom planar surface 332. In-coupled image-bearing light beam 404 may be redirected by the turning grating 352 and may be replicated in at least one dimension. In-coupled image-bearing light beam 404 may be replicated through multiple encounters with the out-coupling diffractive optic 354 along a first direction and the replicated image-bearing light beams may be directed out of the first planar waveguide 320 by the out-coupling diffractive optic 354 as out-coupled image-bearing light beams 406a, 406b, 406c, 406d, 406e (representing central rays of out-coupled image-bearing light beams). This replication of image-bearing light beams results in expansion of the eyebox E in at least one dimension decreasing positional sensitivity of the viewer's eye position.

With continued reference to FIG. 15, in an example embodiment, the in-coupling diffractive optic 350 is a transmissive-type diffractive grating element. In another example embodiment, the in-coupling diffractive optic 350 is positioned on the top planar surface 330 and is a reflective-type diffractive grating element. In an example embodiment, the turning grating 352 is positioned on the top planar surface 330. In an example embodiment, the out-coupling diffractive optic 354 is positioned on the top planar surface 330.

The second planar waveguide 322 includes a top planar surface 334 and a bottom planar surface 336 parallel therewith. The second planar waveguide 322 may further include an in-coupling diffractive optic 360 on bottom planar surface 336. In-coupling diffractive optic 360 may be a surface relief diffraction grating. In another example embodiment, the in-coupling diffractive optic 360 is a holographic diffraction grating. The second planar waveguide 322 may further comprise an intermediate optic 362 operable to redirect and replicate image-bearing light 394 along a first direction. The intermediate optic 362 may also be referred to as a turning optic herein. In an example embodiment, the turning optic 362 is a diffraction grating. The turning optic 362 may also be a holographic diffraction element. The second planar waveguide 322 may further comprise an out-coupling diffractive optic 364. The out-coupling diffractive optic 364 enables light beams propagating within the second planar waveguide 322 to exit the second planar waveguide 322. For example, the out-coupling diffractive optic 364 may be a diffraction grating or a hologram. The out-coupling diffractive optic 364 may provide expansion of the eyebox in one or more dimensions by providing multiple encounters of light beam 394 with one or more sets of periodic diffractive gratings of the out-coupling diffractive optic 364 along one or more directions.

The image light guide system 300A includes an image beam source 390 that produces image-bearing light beam 392. For example, the image beam source 390 may be a pico-projector. In an example embodiment, the image beam source 390 is a pico-projector that produces a single primary color band, (red, green, or blue), of the image to be presented to a viewer looking substantially along the z-axis direction (e.g., along an optical axis within five (5°) degrees of parallel with the z-axis), through the planar waveguides 320, 322, 324. Image beam source 390 may be positioned such that the central ray of the projected image-bearing light beam 392 is substantially perpendicular (e.g., within five (5°) degrees of perpendicular) to the third planar waveguide 324 bottom surface 340. In another example embodiment, the image beam source 390 is positioned such that the central ray of the projected image-bearing light beam 392 is not substantially perpendicular to the third planar waveguide 324 bottom surface 340.

Image-bearing light beam 392 passes through the third planar waveguide 324 to the bottom planar surface 336 of the second planar waveguide 322 where image-bearing light beam 392 is in-coupled into the second planar waveguide 322 by the in-coupling diffractive optic 360 to become in-coupled light beam 394. The in-coupled light beam 394 propagates through the second planar waveguide 322 by TIR between top planar surface 334 and bottom planar surface 336. In-coupled light beam 394 may be redirected by a turning grating 362 and may be replicated into multiple beams along at least one direction. In-coupled light beam 394 may be directed out of planar waveguide 322 by out-coupling diffractive optic 364 and may be replicated along at least one direction to become output beams 396a, 396b, 396c, 396d (representing the central rays of out-coupled image-bearing light beams).

The in-coupling diffractive optic 360 may be a transmissive-type diffractive grating element. In another example embodiment, in-coupling diffractive optic 360 may be positioned on top planar surface 334 and may be a reflective-type diffractive grating element. In an example embodiment, turning grating 362 may be positioned on top planar surface 334. In an example embodiment, the out-coupling diffractive optic 364 may be located on the top planar surface 334.

The third planar waveguide 324 comprises top planar surface 338 and a parallel bottom planar surface 340. The third planar waveguide 324 may further comprise an in-coupling diffractive optic 370 on surface 340. For example, the in-coupling diffractive optic 370 may be a surface relief diffraction grating or a holographic diffraction grating. The third planar waveguide 324 may include an intermediate diffractive optic 372, also referred to herein as a turning grating 372. For example, the turning grating 372 may be a diffraction grating or a volume hologram. The turning grating 372 may replicate a light beam traveling within the third planar waveguide 324 along one or more directions providing pupil or eyebox expansion in the one or more dimensions. The third planar waveguide 324 may further include an out-coupling diffractive optic 374. The out-coupling diffractive optic 374 enables light beams 384 propagating within the third planar waveguide 324 to exit the planar waveguide 324. For example, the out-coupling diffractive optic 374 may be a diffraction grating or a volume hologram. The out-coupling diffractive optic 374 may further provide expansion of the eyebox by replicating light beam 384 as it propagates within the third planar waveguide 324 along one or more directions providing pupil or eyebox expansion in the one or more dimensions.

The image light guide system 300A further includes the image beam source 380 that produces an image-bearing light beam 382. For example, image beam source 380 may be a pico-projector. In an example embodiment, the image beam source 380 is a pico-projector that produces a single primary color band (red, green, or blue) of the image to be presented to a viewer looking substantially along the z-axis direction through the planar waveguides 320, 322, 324. Image beam source 380 may be positioned such that a central ray of the projected image-bearing light beam 382 is substantially perpendicular to the third planar waveguide 324 bottom surface 340. In another example embodiment, the image beam source 380 may be positioned such that the central ray of the projected image-bearing light beam 382 is not perpendicular to the third planar waveguide 324 bottom surface 340.

Image-bearing light beam 382 is incident on the bottom surface 340 of the third planar waveguide 324 where image-bearing light beam 382 is in-coupled by the in-coupling diffractive optic 370 to become in-coupled light beam 384. The in-coupled light beam 384 propagates through the third planar waveguide 324 by TIR between top planar surface 338 and bottom planar surface 340. In-coupled light beam 384 may be redirected by turning grating 372 and may be replicated along at least one direction. In-coupled light beam 384 may be directed out of the third planar waveguide 324 by out-coupling diffractive optic 374 and may be replicated along at least one direction to become output beams 386a, 386b, 386c, 386d, 386e (representing the central rays of out-coupled image-bearing light beams).

In an example embodiment, the in-coupling diffractive optic 370 may be a transmissive-type diffractive grating element. In another example embodiment, the in-coupling diffractive optic 370 may be positioned on top planar surface 338 and may be a reflective-type diffractive grating element. In an example embodiment, the turning grating 372 may be positioned on top planar surface 338. In an example embodiment, out-coupling diffractive optic 374 may be positioned on top planar surface 338.

In some examples, the single primary wavelength band (red) may have a wavelength range of approximately 625 nm to approximately 740 nm, the single primary wavelength band (green) may have a wavelength range of approximately 500 nm to approximately 565 nm, and the single primary wavelength band (blue) may have a wavelength range of approximately 450nm to approximately 485 nm.

In one example embodiment of image light guide system 300A, a first spacing 326 separates the first planar waveguide 320 from the second planar waveguide 322 and a second spacing 328 separates the second planar waveguide 322 from the third planar waveguide 324. In an example embodiment, the spacings 326, 328 comprise substantially air. In another example embodiment, the spacings 326, 328 comprise nitrogen. In another example embodiment, the spacings 326, 328 comprise an inert gas. In yet another example embodiment, the spacings 326, 328 comprise a low index of refraction material, e.g., a material having an index of refraction substantially equal to 1.

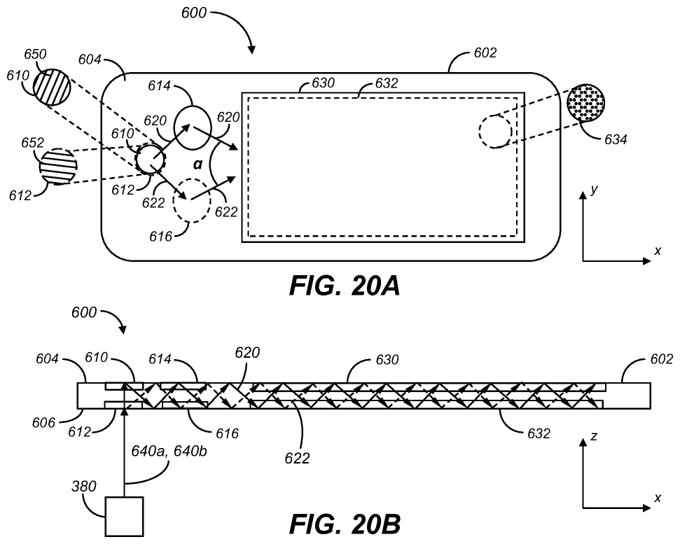

FIG. 16 is a side view of an example embodiment of an image light guide system 300B comprising a first planar waveguide 320, a second planar waveguide 322b, and a third planar waveguide 324b. Where elements of FIG. 16 correspond to like elements of FIG. 15, such elements are commonly referred to with like reference numerals. Third planar waveguide 324b is positioned such that image-bearing light beam 392 from image beam source 390 does not pass through the third planar waveguide 324b. The second planar waveguide 322b is positioned such that image-bearing light beam 402 from image beam source 400 does not pass through the second planar waveguide 322b or the third planar waveguide 324b. In an example embodiment, the length of the third planar waveguide 324b in the x-axis direction is shorter than the length of the second planar waveguide 322b in the x-axis direction. In an example embodiment, the length of the second planar waveguide 322b in the x-axis direction is shorter than the length of first planar waveguide 320 in the x-axis direction. Although not illustrate, in one example embodiment, the planar waveguides 320, 322b, 324b are approximately the same length in the x-axis direction and the second and third planar waveguides 322b, 324b include cut-outs that allow the image-bearing light beams 392, 402 to engage with in-coupling optic elements 360, 350, respectively, without passing through the second and third planar waveguides 322b, 324b.

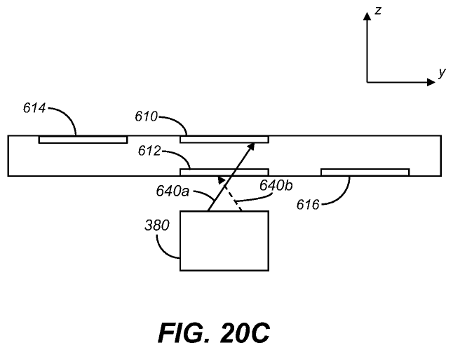

FIG. 17 is a side view of an example embodiment of an image light guide system 300C including a first planar waveguide 320, a second planar waveguide 322, and a third planar waveguide 324. Where elements of FIG. 17 correspond to like elements of FIGS. 15 and 16, such elements are commonly referred to with like reference numerals.

The image light guide system 300C includes an optical element 410 that is operable to redirect image-bearing light beam 382 to the in-coupling diffractive optic 370 such that image-bearing light beam 382 is directed toward the in-coupling diffractive optic 370 at a predetermined angle of incidence. In some examples, image-bearing light beam 382 will be directed toward in-coupling diffractive optic 370 at a predetermined angle of incidence between 0 and 20 degrees with respect to an imaginary line along the path of the image-bearing light beam 382 between the projector 380 and optical element 410.

In an example embodiment, the redirection optical element 410 comprises a prism. For example, the redirection optical element 410 may be a prism assembly comprised of one or more prisms. In an example embodiment, the redirection optical element 410 comprises a specularly reflective surface such as a mirror. For example, the redirection optical element 410 may be a mirror assembly comprised of one or more mirrors. In another embodiment, the redirection optical element 410 may be an assembly of one or more prisms and one or more mirrors.

In an example embodiment, the image light guide system 300C also includes optical element 412 that is operable to redirect image-bearing light beam 392 to in-coupling diffractive optic 360 such that image-bearing light beam 392 is directed toward the in-coupling diffractive optic 360 at a preferred incident angle. As shown, in FIG. 17, image-bearing light beam 392 must pass or transmit through waveguide 324 in its propagation towards in-coupling diffractive optic 360. Since the refractive index of the waveguide 324 substrate is higher than that of the surroundings, the image-bearing light beam 392 will refract when transmitted through the waveguide 324. In an example embodiment, image-bearing light beam 392 will have an angle of incidence on in-coupling diffractive optic 360 of approximately 0° to 20° with respect to an imaginary line along the path of the image-bearing light beam 392 between the projector 390 and optical element 412. In one example embodiment, image-bearing light beam 392 have an angle of incidence of at an angle of approximately 5°. In another example embodiment, image-bearing light beam 392 will have an angle of incidence of approximately 10°. In yet another example embodiment, the image-bearing light beam 392 will have an angle of incidence of at an angel of approximately 15°.

In an example embodiment, the redirection optical element 412 comprises a prism. For example, the redirection optical element 412 may be a prism assembly comprised of one or more prisms. In an example embodiment, the redirection optical element 412 comprises a mirror. For example, the redirection optical element 412 may be a mirror assembly comprised of one or more mirrors. In another example embodiment, the redirection optical element 412 may be an assembly of one or more prisms and one or more mirrors.

In an example embodiment, the image light guide system 300C also includes redirection optical element 414 that is operable to redirect image-bearing light beam 402 to in-coupling diffractive optic 350 such that image-bearing light beam 402 is directed toward the in-coupling diffractive optic 350 at a preferred incident angle. In an example embodiment, the redirection optical element 414 comprises a prism. As shown, in FIG. 17, image-bearing light beam 402 must pass or transmit through waveguides 324 and 322 in its propagation towards in-coupling diffractive optic 350. Since the refractive index of the waveguides 324 and 322 are higher than that of the surroundings, the image-bearing light beam 402 will refract when transmitted through both waveguides 322, 324. In an example embodiment, image-bearing light beam 402 will have an angle of incidence on in-coupling diffractive optic 350 of approximately 0° to 20° with respect to an imaginary line along the path of the image-bearing light beam 402 between the projector 400 and optical element 414. In one example embodiment, image-bearing light beam 402 has an angle of incidence of at an angle of approximately 5°. In another example embodiment, image-bearing light beam 402 will have an angle of incidence of approximately 10°. In yet another example embodiment, the image-bearing light beam 402 will have an angle of incidence of at an angel of approximately 15°. Additionally, in some examples, the redirection optical element 414 may be a prism assembly comprised of one or more prisms. In an example embodiment, the redirection optical element 414 comprises a mirror. For example, the redirection optical element 414 may be a mirror assembly comprised of one or more mirrors. In another example embodiment, the redirection optical element 414 may be an assembly of one or more prisms and one or more mirrors.

In an example embodiment, the redirection optical elements 410, 412, 414 are positioned such that they are not in direct mechanical contact with surface 340 of the third planar waveguide 324. In another example embodiment, the redirection optical elements 410, 412, and 414 indirectly contact surface 340 of third planar waveguide 324, e.g., via one or more layers of index-matched or non-indexed matched transparent or translucent materials.

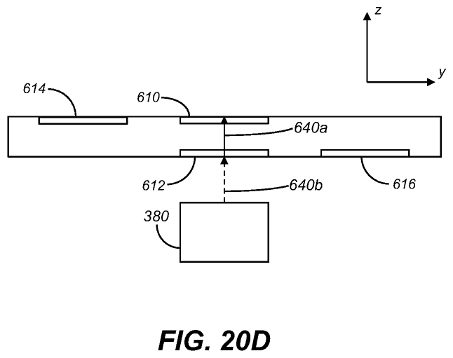

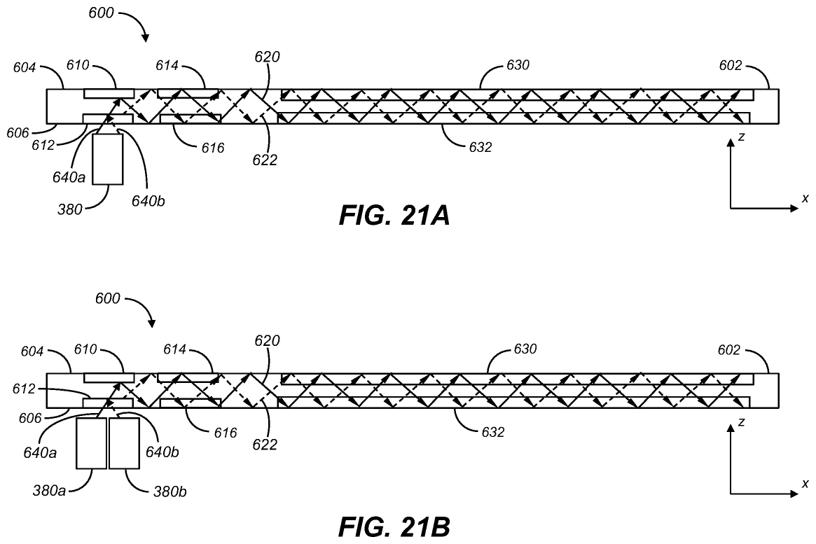

In an example embodiment, as illustrated in in FIGS. 18-19B, an image light guide system 300D includes a first planar waveguide 320 and a second planar waveguide 322d positioned behind first planar waveguide 320 in FIG. 18. Where elements of FIG. 18 correspond to like elements of FIG. 15, such elements are commonly referred to with like reference numerals. In an example embodiment, an in-coupling diffractive optic 350 includes diffraction grating features 420 located on surface 332 of the first planar waveguide 320. The diffraction grating features 420 have a grating vector k3. The image light guide system 300D also includes an in-coupling diffractive optic 360 having diffraction grating features 422 located on surface 336 of the second planar waveguide 322d. The diffraction grating features 422 have a grating vector k2. The image light guide system 300D further includes an in-coupling diffractive optic 370 having diffraction grating features 424 located on surface 336 of the second planar waveguide 322d. The diffraction grating features 424 have a grating vector k1. In an example embodiment, the in-coupling diffractive optic 370 is located on the surface 334 of the second planar waveguide 322d. The in-coupling diffractive optic 360 and the in-coupling diffractive optic 370 may be arranged offset along the x-axis direction as illustrated in FIG. 19A, or they may be arranged without a substantial offset along the x-axis direction as illustrated in FIG. 18.

In an example embodiment, the first planar waveguide 320 includes a first out-coupling diffractive optic 354 having a grating vector k6 and operable to out-couple portions of the image-bearing light beams propagating within the first planar waveguide 320. The second planar waveguide 322d includes a second out-coupling diffractive optic 364 located on/in surface 336 and having a grating vector k4. The second planar waveguide 322d also includes a third out-coupling diffractive optic 374 located on/in the surface 334 and having a grating vector k5. In an example embodiment, combinations of grating vectors ±k3, ±k4, ±k5 form a triangle when the grating vectors are placed tip to tail in a vector diagram. In one example embodiment, the vector triangle is an equilateral triangle. In another example embodiment, the triangle is an isosceles triangle. In yet another example embodiment, the triangle is a scalene triangle. In an example embodiment, the in-coupling diffractive optics 350, 360, 370 are not aligned. For example, the in-coupling diffractive optics 350, 360, 370 may not be aligned along the z-axis direction. In an example embodiment, one or more of the grating vectors ±k1, ±k2, ±k3 are not parallel to one another.

In an example embodiment, as illustrated in FIGS. 19A-19B, the in-coupling diffractive optic 350 is a transmissive-type diffractive grating element. In another example embodiment, the in-coupling diffractive optic 350 is positioned on the surface 330 and is a reflective-type diffractive grating element. In an example embodiment, the out-coupling diffractive optic 354 is positioned on the surface 330 and is a reflective-type diffractive grating element.

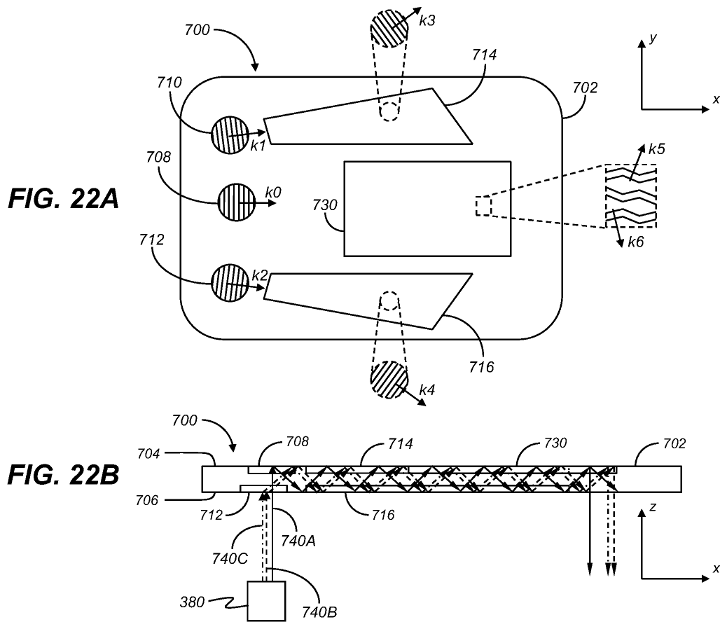

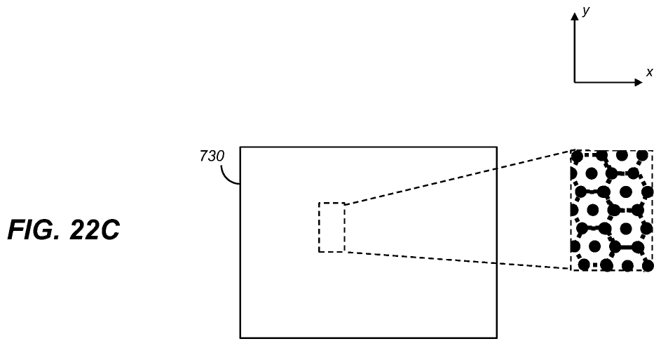

As illustrated in FIGS. 20A-21B, in an example embodiment, an image light guide system 600 includes a waveguide 602 having planar parallel surfaces 604, 606. The planar waveguide 602 includes a first in-coupling diffractive optic 610 located on, in, or engaged with the top planar surface 604, a second in-coupling diffractive optic 612 located on, in, or engaged with the bottom planar surface 606. In an example embodiment, the first in-coupling diffractive optic 610 is optimized to in-couple approximately a first half of the field of view (FOV-not illustrated) from a single color band pico-projector 380 and the second in-coupling diffractive optic 612 is optimized to in-couple approximately a second half of the field of view from the single color band pico-projector 380. In an example embodiment, the angle between light beams 620 and light beams 622 after redirection by the intermediate diffractive optic 614, 616, labeled α, is approximately thirty degrees (30°).

As shown in FIG. 21A, image-bearing light 640a, 640b from the projector 380 is incident upon the first in-coupling diffractive optic 610 and the second in-coupling diffractive optic 612. The first in-coupling diffractive optic 610 is optimized to in-couple image-bearing light 640a corresponding to approximately a first half of the FOV of the projector 380 and the second in-coupling diffractive optic 612 is optimized to in-couple image-bearing light 640b corresponding to approximately a second half of the FOV of projector 380. In some examples, the respective in-coupling diffractive optics 610, 612 can be optimized to in-couple, image-bearing light representative of more than half of the total FOV of the projector. For example, the first in-coupling diffractive optic 610 can be optimized for 60% of the FOV measured from a first side of the FOV of the projector 380 while the second in-coupling diffractive optic 612 can be optimized for 60% of the FOV measured from a second side of the FOV of the projector 380, with a 20% overlap. This is one non-limiting example; however, it should be appreciated that other amounts of overlap are acceptable, e.g., 10%, 15%, 20%, 25%, etc. Because the angular bandwidth, and therefore the FOV, supported by a given waveguide is a function of the pitch of the in-coupling optic (as well as other factors such as, without limitation, TIR condition, thickness of the waveguide, and excessive angle), the FOV cannot be increased by changing the area or footprint of the in-coupling optic alone. Therefore, optimizing each in-coupling diffractive optic 610, 612 to support diffraction of image-bearing light corresponding to half the angular bandwidth of the total FOV enables the waveguide 602 to support a wide FOV without increasing the thickness of the waveguide or changing other factors of the waveguide.

As shown in FIGS. 21A-21B, a portion of the single color band image-bearing light beam 640a from the wide field of view pico-projector 380 is in-coupled into the waveguide 602 by the first in-coupling diffractive optic 610 to become first in-coupled light 620. The first in-coupled light 620 represents image-bearing light of approximately half the field of view of pico-projector 380. The waveguide 602 may include an intermediate diffractive optic 614, also referred to herein as a turning grating 614. For example, the turning grating 614 may be a surface relief grating or a holographic optical element. First in-coupled light 620 is turned by first intermediate optic 614. The first intermediate optic 614 is positioned on, within, or otherwise engaged with the top surface 604 of the waveguide 602. The first intermediate optic 614 may replicate a light beam traveling within the waveguide 602 along one or more directions providing pupil (eyebox) expansion in the one or more dimensions. In an example embodiment, the first intermediate optic 614 does not provide any pupil expansion. Instead, the first intermediate optic 614 can be utilized to redirect light from the first in-coupling diffractive optic 610 toward the first out-coupling diffractive optic 630. In another example embodiment, the first intermediate optic 614 provides at least a minimal amount of pupil expansion in at least one dimension. Light beams 620 propagate within the waveguide 602 by TIR between the top planar surface 604 and the bottom planar surface 606 towards the first out-coupling diffractive optic 630. The first out-coupling diffractive optic 630 enables light beams 620 to exit the planar waveguide 602. The first out-coupling diffractive optic 630 may be positioned on, within, or otherwise engaged with the top surface 604 of the waveguide 602.

Another portion of the single color band image-bearing light beam 640b from the wide field of view pico-projector 380 is in-coupled into the waveguide 602 by the second in-coupling diffractive optic 612 to become second in-coupled light 622. The second in-coupled light 622 represents image-bearing light of approximately the remaining half of the field of view of pico-projector 380. The waveguide 602 may include a second intermediate diffractive optic 616, also referred to herein as a turning grating 616. For example, the turning grating 616 may be a surface relief grating or a holographic optical element. Second in-coupled light 622 is turned by the second intermediate optic 616. The second intermediate optic 616 is positioned on, within, or otherwise engaged with the bottom surface 606 of the waveguide 602. The second intermediate optic 616 may replicate a light beam traveling within the waveguide 602 along one or more directions providing pupil expansion in the one or more dimensions.

In an example embodiment, the second intermediate optic 616 does not provide any pupil expansion. Instead, the second intermediate optic 616 can be utilized to redirect light from the second in-coupling diffractive optic 612 toward the second out-coupling diffractive optic 632. In another example embodiment, the second intermediate optic 616 provides a minimal amount of pupil expansion in at least one dimension. Light beams 622 propagate within the waveguide 602 by TIR between the top planar surface 604 and the bottom planar surface 606 towards the second out-coupling diffractive optic 632. The second out-coupling diffractive optic 632 enables light beams 622 to exit the planar waveguide 602. The second out-coupling diffractive optic 632 may be positioned on, in, or otherwise engaged with the bottom surface 606 of the waveguide 602. Importantly, as shown in FIG. 20A the direction of propagation of first in-coupled light 620 is orthogonal, i.e., rotated 90 degrees with respect to the direction of propagation of second in-coupled light 622. This configuration reduces cross-talk between the in-coupled light. Additionally, in some examples, the intermediate turning optics 614, 616, are configured to redirect these orthogonal portions of light, without replication, such that the in-coupled portions of light 620, 622, are directed toward the respective out-coupling diffractive optics 630, 632.

Further, in an example embodiment, neither the first intermediate optic 614 nor the second intermediate optic 616 provides any pupil expansion. Rather, the first and second intermediate optics 614, 616 direct the diffracted image-bearing light towards the center of the first out-coupling optic 630 and the second out-coupling optic 632. In such an embodiment, the first and second intermediate optics 614, 616 may be proximate the first and second in-coupling optics 610, 612 wherein substantially all of the image-bearing light diffracted by either the first or second in-coupling optics 610, 612 encounters either the first or second intermediate optic 614, 616.

Referring now to FIGS. 20A and 21A, in one example embodiment, the first in-coupling optic 610 includes periodic linear grating structures 650 and the second in-coupling optic 612 includes periodic linear grating structures 652 that are oriented orthogonal to the periodic linear grating structures 650 and may have a different pitch compared to the periodic linear grating structures 650 of the first in-coupling optic 610. In one example embodiment, to optimize the first in-coupling optic 610 and the second in-coupling optic 612 to in-couple image-bearing light representing respective halves of the FOV of a projector, the pitch of the periodic linear grating structures 650 of the first in-coupling optic 610 is approximately 450 nm and the pitch of the periodic linear grating structures 652 of the second in-coupling optic 612 is approximately 350 nm. In another embodiment as illustrated in FIGS. 20B and 20C, the periodic linear grating structures 650 of the first in-coupling optic 610 have the same pitch as the periodic linear grating structures 652 of the second in-coupling optic 612, and the periodic linear grating structures 650 are oriented orthogonal (e.g., rotated 90°) relative to the periodic linear grating structures 652. In other words, the first and second in-coupling diffractive optics 610, 612 may have diffractive features with the same pitch, where the direction of periodicity of the diffractive features of the second in-coupling diffractive optic 612 are oriented approximately ninety-degrees (90°) relative to the direction of periodicity of the diffractive features of the first in-coupling diffractive optic 610 to reduce crosstalk.

The diffractive grating features of the first and second out-coupling optics 630, 632 may comprise compound grating features 634. In one example embodiment, the compound grating features 634 of the first and second out-coupling optics 630, 632 comprise a plurality of posts with regular variation in at least one of the two or more directions. In another example embodiment, the diffractive grating features 634 of the first and second out-coupling optics 630, 632 comprise diamond shaped posts.

As stated above, the pico-projector 380 may have a wide field of view. In an example embodiment, the pico-projector 380 generates an image in a single wavelength band (e.g., the red, green, or blue wavelength band) having a field of view greater than thirty degrees. In an example embodiment, the pico-projector 380 may have a field of view greater than approximately forty-five degrees. In an example embodiment, the image light guide system 600 includes two pico-projectors 380a, 380b as shown in FIG. 21B, each providing approximately half of the field of view. As shown in FIG. 21B, image-bearing light 640a from the projector 380a is incident upon the first in-coupling diffractive optic 610 and provides image-bearing light representing a first half of the total field of view, while image-bearing light 640b from the projector 380b is incident upon the second in-coupling diffractive optic 612 and provides image-bearing light representing a second half of the total field of view.

The first out-coupling diffractive optic 630 may be a surface relief grating or holographic optical element and provide pupil expansion in at least one dimension. The first out-coupling diffractive optic 630 may provide pupil expansion in two orthogonal dimensions. In an example embodiment, the first out-coupling diffractive optic 630 may comprise crossed grating features. In another example embodiment, the first out-coupling diffractive optic 630 may comprise a first set of posts forming a 2D photonic crystal. For example, the first set of posts may be circular, elliptical, diamond, rectangular, hexagonal, octagonal, or other shapes. In another example embodiment, the first out-coupling diffractive optic 630 may comprise grating structures having non-linear and/or non-straight, grating features.

The second out-coupling diffractive optic 632 may be a surface relief grating or holographic optical element and provide pupil expansion in at least one dimension. The second out-coupling diffractive optic 632 may provide pupil expansion in two orthogonal dimensions. In an example embodiment, the second out-coupling diffractive optic 632 may comprise crossed grating features. In another embodiment, the second out-coupling diffractive optic 632 may comprise a second set of posts forming a 2D photonic crystal. For example, the second set of posts may be circular, elliptical, diamond, rectangular, hexagonal, octagonal, or other shapes. In an example embodiment, the second out-coupling diffractive optic 632 may comprise diffractive grating structures having non-linear, non-straight, grating features.

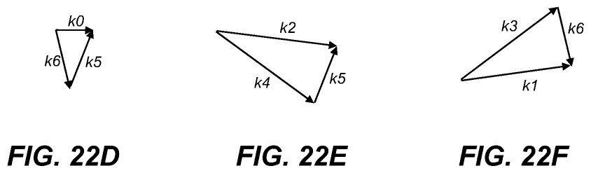

Referring now to FIGS. 22A and 22B, in an example embodiment, an image light guide system 700 includes a planar waveguide 702 having a first surface 704 and a second surface 706. The waveguide first surface 704 is positioned generally parallel with the waveguide second surface 706. A first in-coupling diffractive optic 708 is located on, in, or is otherwise engaged with the first surface 704, a second in-coupling diffractive optic 710 is located on, in, or is otherwise engaged with the second surface 706, and a third in-coupling diffractive optic 712 is located on, in, or is otherwise engaged with the second surface 706. The first, second, and third in-coupling diffractive optics, 708, 710, 712 are relatively offset from one another along the y-axis direction.

A first intermediate diffractive optic 714, also referred to herein as a turning grating, is located on, in, or is otherwise engaged with the first surface 704, and a second intermediate diffractive optic 716 is located on, in, or is otherwise engaged with the second surface 706 wherein the second intermediate diffractive optic is offset from the first intermediate diffractive optic 714 along at least the y-axis. For example, the turning grating 714 may be a surface relief grating or a holographic optical element.

An out-coupling diffractive optic 730 is formed on, in, or is otherwise engaged with the first surface 704. In an example embodiment, the out-coupling diffractive optic 730 is formed on, in, or is otherwise engaged with the second surface 706. In an example embodiment, the out-coupling diffractive optic 730 is a surface relief grating. In another example embodiment, the out-coupling diffractive optic 730 is a holographic optical element. As illustrated in FIG. 22A, in an example embodiment, the out-coupling diffractive optic 730 comprises a compound grating pattern having periodicity in two or more directions. For example, the out-coupling diffractive optic 730 comprises wavy diffractive features creating periodicity in the k5 and k6 grating vector directions by regular variations of the diffractive features in the y-coordinate direction. In an example embodiment, the regular variation of the diffractive features produces a saw tooth pattern. In another example embodiment, the regular variation of the diffractive features produces a sinusoidal wave pattern. In another example embodiment, the diffractive features comprise a plurality of posts with regular variation in at least one of the two or more directions as illustrated in FIG. 22C.

In an example embodiment, shown in FIGS. 22A-22B, a first wavelength range of image-bearing light 740A is in-coupled by the first in-coupling diffractive optic 708 and propagates to the out-coupling diffractive optic 730 where the image-bearing light 740A is diffracted via multiple encounters with the compound grating pattern along two directions to expand the eyebox in two dimensions (e.g., along the x and y-directions) and out-couple the image-bearing light 740A. The optical path of the first wavelength range of image-bearing light 740A may be represented by the vector diagram in FIG. 22D, where the grating vectors k0, k5, and k6 sum to substantially zero.

In an example embodiment, a second wavelength range of image-bearing light 740B is in-coupled by the second in-coupling diffractive optic 710 and propagates to the first intermediate diffractive optic 714 where the image-bearing light 740B is directed to the out-coupling diffractive optic 730. The optical path of the second wavelength range of image-bearing light 740B may be represented by the vector diagram in FIG. 22E, where the grating vectors k1, k3, and k6 sum to substantially zero.

Similarly, a third wavelength range of image-bearing light 740C is in-coupled by the third in-coupling diffractive optic 712 and propagates to the second intermediate diffractive optic 716 where the image-bearing light 740B is directed to the out-coupling diffractive optic 730. The optical path of the third wavelength range of image-bearing light 740C may be represented by the vector diagram in FIG. 22F, where the grating vectors k2, k4, and k5 sum to substantially zero.

This arrangement enables the waveguide 702 to support three optical paths for three wavelength ranges or angular ranges of image-bearing light.

The wavy pattern appears to the approaching image-bearing light as a near-linear grating pattern as it approaches from the turn direction.

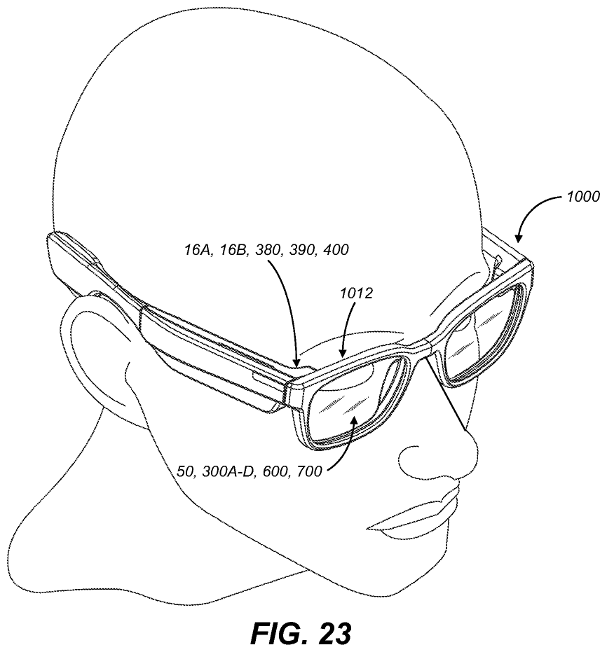

The perspective view shown in FIG. 23 illustrates one example of the image light guide systems 50, 300A-D, 600, 700 in a display system 1000 for augmented reality viewing of virtual images. The image light guide system 50, 300A-D, 600, 700 uses one or more image light guides described above. Display system 1000 is shown as an HMD with a right-eye rim section 1012 having an image light guide system 50, 300A-D, 600, 700 proximate the user's right-eye. The display system 1000 includes an image source 16A, 16B, 380, 390, 400, such as a picoprojector or similar device, energizable to generate one or more virtual images conveyed to the image light guide system 50, 300A-D, 600, 700. In an example embodiment, the display system 1000 includes a left-eye rim section having an image light guide system 50, 300A-D, 600, 700 proximate the user's left-eye and a second image source 16A, 16B, 380, 390, 400 energizable to generate one or more virtual images conveyed to the image light guide system 50, 300A-D, 600, 700 of the left-eye rim section. In examples using an image light guide system 50, 300A-D, 600, 700 in both a right-eye rim section 1012 and a left-eye rim section, the virtual images that are generated can be a stereoscopic pair of images for 3-D viewing. During operation by a user or viewer, the virtual image that is formed by the display system 1000 can appear to be superimposed or overlaid onto the real-world scene content seen by the viewer through an image light guide system 50, 300A-D, 600, 700 of a right-eye rim section 1012 and/or a left-eye rim section. Additional components familiar to those skilled in the augmented reality visualization arts, such as one or more cameras mounted on the frame of the display system 1000 for viewing scene content or viewer gaze tracking, can also be provided.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. An image light guide system for conveying a virtual image, comprising:
a first waveguide operable to propagate image-bearing light beams;
a first in-coupling diffractive optic formed along the first waveguide, wherein the first in-coupling diffractive optic is operable to diffract a first portion of image-bearing light beams into the first waveguide in an angularly encoded form;
a first out-coupling diffractive optic formed along the first waveguide, wherein the first out-coupling diffractive optic is operable to replicate the first portion of image-bearing light beams in two directions and direct the replicated image-bearing light beams from said first waveguide in an angularly decoded form;
a second in-coupling diffractive optic formed along the first waveguide, wherein the second in-coupling diffractive optic is operable to diffract a second portion of image-bearing light beams into the first waveguide in an angularly encoded form;
a second out-coupling diffractive optic formed along the first waveguide, wherein the second out-coupling diffractive optic is operable to replicate the second portion of image-bearing light beams in two directions and direct the replicated image-bearing light beams from the first waveguide in an angularly decoded form;
a second waveguide operable to propagate image-bearing light beams;
a third in-coupling diffractive optic formed along the second waveguide, wherein the third in-coupling diffractive optic is operable to diffract a third portion of image-bearing light beams into the second waveguide in an angularly encoded form;
a third out-coupling diffractive optic formed along the second waveguide, wherein the third out-coupling diffractive optic is operable to replicate the third portion of image-bearing light beams in two directions and direct the replicated image-bearing light beams from the second waveguide in an angularly decoded form;
a fourth in-coupling diffractive optic formed along the second waveguide, wherein the fourth in-coupling diffractive optic is operable to diffract a fourth portion of image-bearing light beams into the second waveguide in an angularly encoded form; and
a fourth out-coupling diffractive optic formed along the second waveguide, wherein said fourth out-coupling diffractive optic is operable to replicate the fourth portion of image-bearing light beams in two directions and direct the replicated image-bearing light beams from the second waveguide in an angularly decoded form.

2. The image light guide system of claim 1, wherein the first waveguide is arranged substantially parallel with the second waveguide along a first axis, and wherein at least one of (a) the first in-coupling diffractive optic and the third in-coupling diffractive optic are located substantially coaxial along a second axis that is substantially orthogonal to the first axis, or (b) the second in-coupling diffractive optic and the fourth in-coupling diffractive optic are located substantially coaxial along the second axis that is substantially orthogonal to the first axis.

3. (canceled)

4. The image light guide system of claim 1, wherein the first portion of image-bearing light beams comprises image-bearing light of a first wavelength range, and the second portion of image-bearing light beams comprises image-bearing light of a second wavelength range, wherein the second wavelength range is different than the first wavelength range, and wherein the third portion of image-bearing light beams comprises image-bearing light of a third wavelength range, and the fourth portion of image-bearing light beams comprises image-bearing light of the second wavelength range.

5. (canceled)

6. The image light guide system of claim 1, further comprising a first image source operable to emit the first and third portions of image-bearing light beams, and a second image source operable to emit the second and fourth portions of image-bearing light beams.

7. The image light guide system of claim 1, wherein the first in-coupling diffractive optic includes a first plurality of periodic diffractive structures, wherein the first out-coupling diffractive optic includes a second plurality of periodic diffractive structures and a third plurality of periodic diffractive structures, wherein an orientation of the second plurality of periodic diffractive structures is angularly offset relative to an axis perpendicular to the first plurality of periodic diffractive structures by a polar angle of less than thirty degrees, and wherein an orientation of the third plurality of periodic diffractive structures is angularly offset relative to the axis by a polar angle greater than sixty degrees.

8. The image light guide system of claim 7, wherein the first plurality of periodic diffractive structures comprises a first period, the second plurality of periodic diffractive structures comprise a second period, and the third plurality of periodic diffractive structures comprises a third period, wherein the third period is substantially equal to the second period, and the second period is substantially equal to the first period.

9. (canceled)

10. The image light guide system of claim 7, wherein the second in-coupling diffractive optic includes a fourth plurality of periodic diffractive structures, wherein the second out-coupling diffractive optic includes a fifth plurality of periodic diffractive structures and a sixth plurality of periodic diffractive structures, wherein an orientation of the fifth plurality of periodic diffractive structures is angularly offset relative to the second plurality of periodic diffractive structures by approximately thirty degrees (30°), and wherein an orientation of the sixth plurality of periodic diffractive structures is angularly offset relative to the third plurality of periodic diffractive structures by approximately thirty degrees (30°).

11. The image light guide system of claim 10, wherein the fourth plurality of periodic diffractive structures comprises a first period, the fifth plurality of periodic diffractive structures comprise a second period, and the sixth plurality of periodic diffractive structures comprises a third period, and wherein the third period is equal to the second period, and the second period is equal to the first period.

12. (canceled)

13. The image light guide system of claim 10, wherein the third in-coupling diffractive optic includes a seventh plurality of periodic diffractive structures, wherein the third out-coupling diffractive optic includes an eighth plurality of periodic diffractive structures and a ninth plurality of periodic diffractive structures, wherein an orientation of the eighth plurality of periodic diffractive structures is angularly offset relative to an axis perpendicular to the seventh plurality of periodic diffractive structures by a polar angle of less than thirty degrees, and wherein an orientation of the ninth plurality of periodic diffractive structures is angularly offset relative to the axis perpendicular to the seventh plurality of periodic diffractive structures by a polar angle greater than sixty degrees.

14. The image light guide system of claim 13, wherein the seventh plurality of periodic diffractive structures comprises a first period, the eighth plurality of periodic diffractive structures comprise a second period, and the ninth plurality of periodic diffractive structures comprises a third period, and wherein the third period is equal to the second period, and the second period is equal to said first period.

15. (canceled)

16. The image light guide system of claim 13, wherein the fourth in-coupling diffractive optic includes a tenth plurality of periodic diffractive structures, wherein the fourth out-coupling diffractive optic includes an eleventh plurality of periodic diffractive structures and a twelfth plurality of periodic diffractive structures, wherein an orientation of said eleventh plurality of periodic diffractive structures is angularly offset relative to the eighth plurality of periodic diffractive structures by approximately thirty degrees, and wherein an orientation of said twelfth plurality of periodic diffractive structures is angularly offset relative to the ninth plurality of periodic diffractive structures by approximately thirty degrees, wherein the tenth plurality of periodic diffractive structures comprises a first period, the eleventh plurality of periodic diffractive structures comprise a second period, and the twelfth plurality of periodic diffractive structures comprises a third period, and wherein the third period is equal to the second period, and the second period is equal to the first period.

17. (canceled)

18. (canceled)

19. The image light guide system of claim 1, further comprising a birefringent polarization control element located between the second in-coupling diffractive optic and the fourth in-coupling diffractive optic.

20. The image light guide system of claim 6, wherein the first image source comprises a first projector operable to emit the first portion of image-bearing light beams comprising image-bearing light of a first wavelength range and the third portion of image-bearing light beams comprising image-bearing light of a second wavelength range different from the first wavelength range, and wherein the second image source comprises a second projector operable to emit the second and fourth portions of image-bearing light comprising image-bearing light of a third wavelength range.

21. The image light guide system of claim 20, wherein one of the first wavelength range and the second wavelength range includes wavelengths between 440-470 nm and wherein the other one of the first wavelength range and the second wavelength range includes wavelengths between 560-520 nm; and wherein the third wavelength range includes wavelengths between 630-660 nm.

22-40. (canceled)

41. An image light guide system for conveying a virtual image, comprising:
a waveguide operable to propagate image-bearing light beams;
a first in-coupling diffractive optic formed along the waveguide, wherein the first in-coupling diffractive optic is operable to diffract a first portion of image-bearing light beams into the waveguide in an angularly encoded form;
a second in-coupling diffractive optic formed along the waveguide, wherein the second in-coupling diffractive optic is operable to diffract a second portion of image-bearing light beams into the waveguide in an angularly encoded form;
a third in-coupling diffractive optic formed along the waveguide, wherein the third in-coupling diffractive optic is operable to diffract a third portion of image-bearing light beams into the waveguide in an angularly encoded form;
an out-coupling diffractive optic formed along the waveguide, wherein the first out-coupling diffractive optic is operable to replicate the first, second and third portion of image-bearing light beams in at least one direction and direct the replicated image-bearing light beams from the waveguide in an angularly decoded form.

42. The image light guide system of claim 41, further comprising:
a first intermediate diffractive optic located in an optical path between the first in-coupling diffractive optic and the out-coupling diffractive optic; and
a second intermediate diffractive optic is located in an optical path between the second in-coupling diffractive optic and the out-coupling diffractive optic.

43. The image light guide system of claim 41, wherein the out-coupling diffractive optic includes compound diffractive structures having a periodicity in two or more directions.

44. The image light guide system of claim 43, wherein the compound diffractive structures are wavy diffractive features having regular variations of the diffractive features in the y-axis direction.

45. The image light guide system of claim 44, wherein the wavy diffractive features define a sawtooth pattern.

46. The image light guide system of claim 44, wherein the wavy diffractive features define a sinusoidal pattern.
